(19) United States
(12) Patent Application Publication
(10) Pub. No.: US 2013/0218605 A1
(43) Pub. Date: Aug. 22, 2013

(54) Systems and methods for improved bond purchasing

(71) Applicant: Wayne Nunziata, Montvale, NJ (US)

(72) Inventor: Wayne Nunziata, Montvale, NJ (US)

(73) Assignee: Colonial Surety Company, Vernon, NJ (US)

(21) Appl. No.: 13/481,053

(22) Filed: May 25, 2012

Related U.S. Application Data
(60) Provisional application No. 61/601,342, filed on Feb. 21, 2012.

(51) Int. Cl. G06Q 20/40; G06Q 40/08

(52) U.S. Cl. 705/4; 705/44

(57) ABSTRACT

A computer-implemented method and apparatus for processing and issuing bonds in a remote computer bond processing system. The method including the steps of, a user, via an on-line connected computer device, accesses the remote computer bond processing system for providing information relating to a bond purchase request. The user bond request is then validated in the remote computer bond processing system dependent upon he user inputted information relating to a bond purchase request. The requested bond is issued to the user, in real-time, contingent upon successful validation of said user bond request. The user may then immediately obtain and print an issued bond, via an on-line connected computer device.

### FIELD OF THE INVENTION

The invention generally relates to bonds, including insurance bonds, and, more particularly, to a system and method for improved bond purchasing.

### BACKGROUND OF THE INVENTION

By the term surety bond is generally meant a bond issued by an insurance or other company as surety on behalf of a principal whereby the surety legally binds itself to an obligee for an amount of money guaranteed to the obligee for the faithful performance of a contract or other act of the principal. The bonds of the present invention can include bid bonds, contract, court and subdivision bonds, performance bonds, customs bonds, notary bonds, liquor license bonds, license and permit bonds, small business administration bonds, bail bonds, supersedeas bonds or other bonds required in litigation, etc. Also applicable to the invention are binding certificates of insurance and policy endorsements and other insurance related documentation.

When a contractor, builder or supplier etc. wishes to bid on a construction project or submit a bid in connection with a governmental purchase of equipment or supplies the entity seeking bid typically requires that for a bidder to be considered for the job a bid bond must be submitted with the bid. Many municipalities have their own bid form and others use a format approved of by the American Institute of Architects. In the typical hid bond the principal is the person who is submitting the bid. The surety is typically an insurance or bonding company who pursuant to the bond is “held and firmly bound” to the entity seeking the bid for a predetermined sum, usually some percentage of the bid amount. In the event the bid is accepted the bond becomes effective and protects the entity awarding the contract by assuring the entity of faithful performance of the contract as well as prompt payment of labor and materials furnished in performing the contract. In addition, the bond protects the bid seeking entity from the failure of the winning bidder from ultimately entering into the contract that is being awarded by paying the difference between the winning bid and the amount that the entity would have to pay to another party to complete the project because of the default.

Each bidder submits a bid bond with its bid in the appropriate form decided upon by the entity seeking the bids. In the event the wrong form of bid bond is used the party submitting the bond runs the risk that the entity soliciting the bonds will reject the bid out of hand even if the person submitting the bond was the low bidder. Many agencies soliciting bids are reluctant to accept a bid with an improper bid bond form because there is a risk that the losing bidders who submitted the proper form may challenge the agency if it awards the bid to based on an improper bid form.

When a contractor, for example, is submitting a bid, much of the contractor's effort is spent massaging the bid to make sure the contractor has a bid that he considers is his best for the particular job. Since much of the pre bid effort is spent calculating and recalculating material and/or labor costs, frequently a bid bond is not sought by the contractor until just before the bidding deadline. In addition, many contractors are bidding on a plurality of jobs at a time. Furthermore, for many projects and contracts there are multiple bidders bidding on the project. For the non winning bidders their bond terminates and only the winning bidder's bond has any effect. As a result a great deal of effort has to be done in a short period of time to prepare multiple bonds.

Surety companies typically rely on local agents to receive the bond request and process the necessary paper work to complete the bid bond. For certain bond requests where the amount of the bond request is low the agent may have authority to issue a bond without approval from the surety company. For other requests the surety company must approve the bond requests. One of the problems that agents have in submitting bonds for approval is that the requests are typically faxed to a central location at the surety company where they sit for an extended period of time before the request is presented to the proper person for approval of the request. Once the bond request is approved, the agent must prepare the actual bond which must be signed by the agent on behalf of the surety company. In order to save time in the process many surety companies provide their agents with executed powers of attorney for them to retain at their offices until needed. While this procedure saves considerable time in the procedure of issuing bonds there is also the risk that an agent could issue a bond inappropriately to an unsatisfactory party. While the procedure described above is for bid bonds, the current steps and procedures for issuing other types of bonds are similar.

As a result of the time deadlines and security issues in the current methods and procedures for issuing bonds there is a need for improved methods and apparatus for obtaining bonds.

### SUMMARY OF THE INVENTION

The invention is directed to improved methods, apparatus and system for issuing and transmitting surety bonds, including but not limited to bid bonds, contract, court and subdivision bonds, performance bonds, customs bonds, notary bonds, liquor license bonds, license and permit bonds, small business administration bonds, bail bonds, supersedeas bonds or other bonds required in litigation, etc. The present invention also has applicability in the field of insurance and other businesses including but not limited to binding certificates of insurance and policy endorsements. The invention relates generally to computerized systems and more particularly to a computerized system for automated issuances of bonds through a communications linkage for communicating and processing information necessary for the issuance of a bond in a timely and efficient manner. The invention also relates to a system for the collection, processing, and dissemination of bond related information generated from the application process.

The invention relates to a computerized system and method for purchasing and issuing bonds. An embodiment of the invention relates to a computerized system and method for purchasing and issuing bonds from virtually any location having access to a computer device coupled to the internet whereby a user can process bid bonds; purchase bonds (e.g., ERISA fidelity bonds); and purchase Error and Omission Insurance.

An aspect of the invention relates to “on-line” bond processing (e.g., via the internet or another like link networked environment) in which a user can input vital information regarding a bid bond whereby the inventive system and method validates this information and enables the user to immediately, and locally, print the issued bond. It is to be appreciated the inventive system and method further preferably enables “last minute” changes to such issuance of a bond.

Further aspects of the invention provide a line of credit to a user (e.g., a bid bond) as well as issuance of a power-of-attorney to facilitate decision making. A yet further aspect of the invention provides Fiduciary Liability Insurance to a user.

Thus, an embodiment of the invention enables a user to instantly validate a bond request and thereafter instantly purchase and print the bond. Further, a user can via on instant on-line process, purchase Error and Omissions Insurance.

### BRIEF DESCRIPTION OF THE DRAWINGS

The objects and features of the invention can be understood with reference to the following detailed description of illustrative embodiments of the present invention taken together in conjunction with the accompanying drawings in which:

FIG. 1A depicts an exemplary computer system that may be used with an illustrative embodiment of the present invention;

FIGS. 1B and 1C depict various steps performed by the system of FIG. 1A in accordance with certain illustrated embodiments of the invention;

FIGS. 2-11 depict various screen shots of embodiments for a bond purchase process performed by the system of FIG. 1A in accordance with certain illustrated embodiments of the invention;

FIGS. 12-17 depict various screen shots of embodiments for Employee Retirement Income Security Act (ERISA) bonds purchase process performed by the system of FIG. 1A in accordance with certain illustrated embodiments of the invention;

FIG. 18 depicts a screen shot of a pension professional website in accordance with certain illustrated embodiments of the invention;

FIGS. 19-24 depict various screen shots of embodiments for an interactive bond purchase management process performed by the system of FIG. 1A in accordance with certain illustrated embodiments of the invention; and

FIGS. 25-27 depict various screen shots of embodiments for application for Error and Omissions Insurance performed by the system of FIG. 1A in accordance with certain illustrated embodiments of the invention.

### WRITTEN DESCRIPTION OF CERTAIN EMBODIMENTS OF THE INVENTION

The present invention is now described more fully with reference to the accompanying drawings, which illustrate various embodiments of the present invention. The present invention is not limited to any of these illustrated embodiments since they are provided as merely exemplary embodiments of the subject disclosure, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention. It is also noted and to be appreciated, there are instances below in which a service provider of the present invention is termed “Colonial”, “Colonial Surety” or “Colonial Surety Report”.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

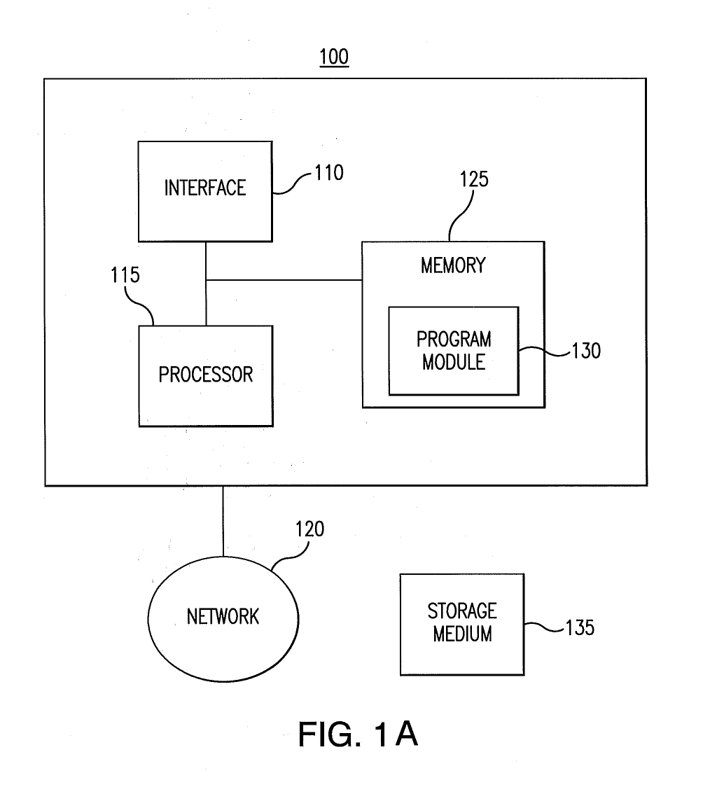

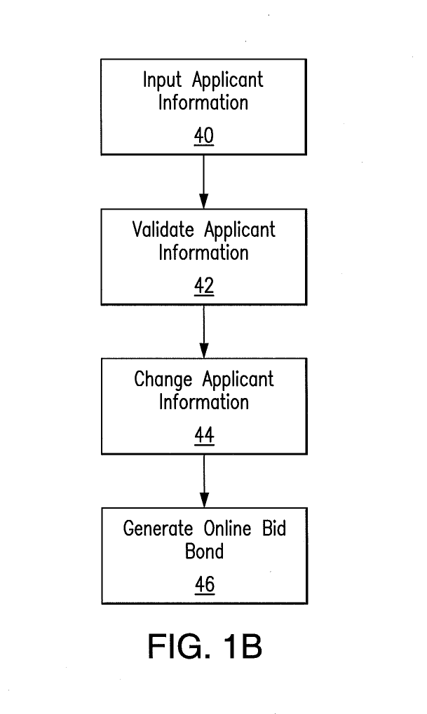

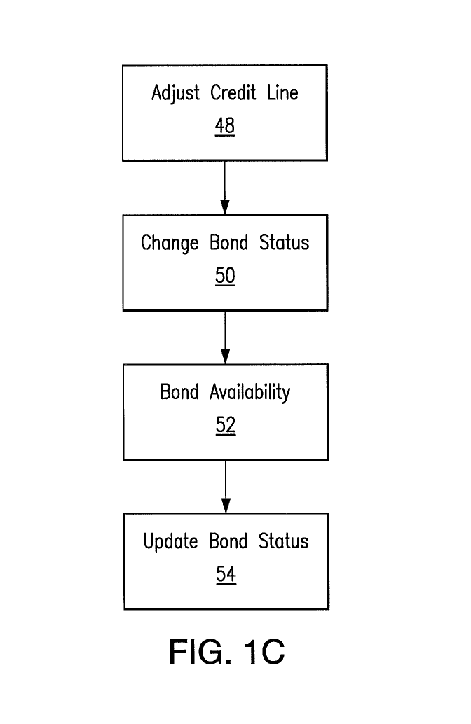

Turning now descriptively to the drawings, in which similar reference characters denote similar elements throughout the several views, FIG. 1A depicts an exemplary general-purpose computing system in which illustrated embodiments of the present invention may be implemented.

FIG. 1A depicts an exemplary computer system, i.e., system 100, which may be used with an illustrative embodiment of the present invention. System 100 generally includes at least one processor 115, or processing unit or plurality of processors, at least one interface 110, e.g., a user-interface, and a memory 125 coupled together via a bus or group of buses 112. Although system 100 is represented herein as a standalone device, it is not limited to such, but instead can be coupled to other devices (not shown) in a distributed processing system.

Interface 110 includes an input device, such as a keyboard or speech recognition subsystem, for enabling a user to communicate information and command selections to processor 115. Interface 110 also includes an output device such as a display. A cursor control such as a mouse, track-ball, or joy stick, allows the user to manipulate a cursor on the display for communicating additional information and command selections to processor 115. Interface 110 is also provided for coupling the processing system 100 to one or more peripheral devices. Input to interface 110 can be derived from multiple sources, for example keyboard instructions in conjunction with data received via a network 120. Output from interface 110 produces or generates output data and can comprise, for example, a display device or monitor in which case output data is visual, a printer in which case output data is printed, a port for example a USB port, a peripheral component adaptor, a data transmitter or antenna such as a modem or wireless network adaptor, etc. Output data can also be distinct and derived from different output devices, for example a visual display on a monitor in conjunction with data transmitted to network 120. A user could view data output, or an interpretation of the data output, on, for example, a monitor or using a printer.

Processor 115 is an electronic device configured of logic circuitry that responds to and executes instructions. The processor 115 could comprise more than one distinct processing device, for example to handle different functions within the processing system 100. Processor 115 outputs, to user interface 110, a result of an execution of the methods described herein. Alternatively, processor 115 could direct the output to a remote device (not shown) via network 120.

Memory 125 is a computer-readable medium encoded with a computer program. In this regard, memory 125 stores data and instructions that are readable and executable by processor 115 for controlling the operation of processor 115. Memory 125 may be implemented in a random access memory (RAM), volatile or non-volatile memory, solid state storage devices, magnetic devices, a hard drive, a read only memory (ROM), or a combination thereof. One of the components of memory 125 is a program module 130.

Program module 130 contains instructions for controlling processor 115 to execute the methods described herein. The term “module” is used herein to denote a functional operation that may be embodied either as a stand-alone component or as an integrated configuration of a plurality of sub-ordinate components. Thus, program module 130 may be implemented as a single module or as a plurality of modules that operate in cooperation with one another. Moreover, although program module 130 is described herein as being installed in memory 125, and therefore being implemented in software, it could be implemented in any of hardware (e.g., electronic circuitry), firmware, software, or a combination thereof.

In use, system 100 is adapted to allow data or information to be stored in and/or retrieved from, via wired or wireless communication means, at least one database (not shown). Processor interface 110 can provide wired and/or wireless communication the processor 115 and peripheral components that may serve a specialized purpose. Preferably, processor 115, under the control of instructions from program module 130, receives input data via network 120 or interface 110. Processor 115 further processes this input data to yield resultant processed data. Processor 115 further provides the processed data as output data to interface 110 or to network 120 for further transmission. It should be appreciated that the processing system 100 may be any form of terminal, server, specialized hardware, or the like.

It is to be further appreciated that network 120 depicted in FIG. 1A can include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device such as storage medium 135. It is to be appreciated that the illustrated network connections of FIG. 1A are exemplary and other means of establishing a communications link between multiple computers may be used.

FIG. 1A is intended to provide a brief, general description of an illustrative and/or suitable exemplary environment in which embodiments of the below described present disclosure may be implemented. FIG. 1A is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1A. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld (e.g., smart phones, tablet devices, etc.) or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

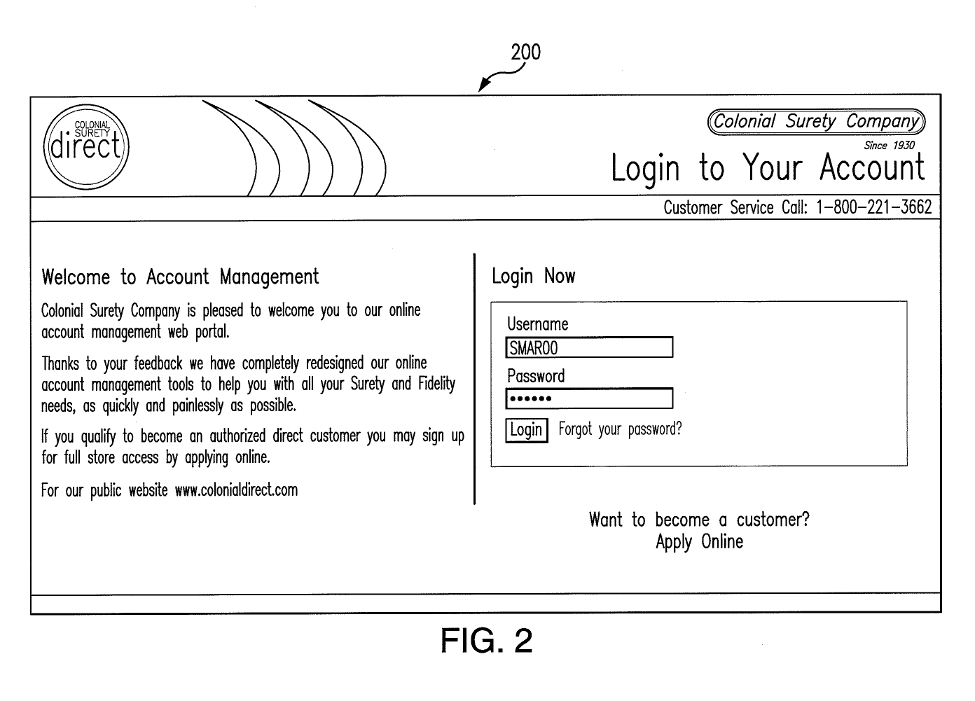

With reference now to FIGS. 2-8, illustrated are various screen shots of embodiments for a bond purchase process and improvements thereto as integrated with the above described illustrated system 100. In particular, FIGS. 2-8 depict resultant screen shots from the bond purchase process as performed and executed by the system 100 of the invention of FIG. 1A.

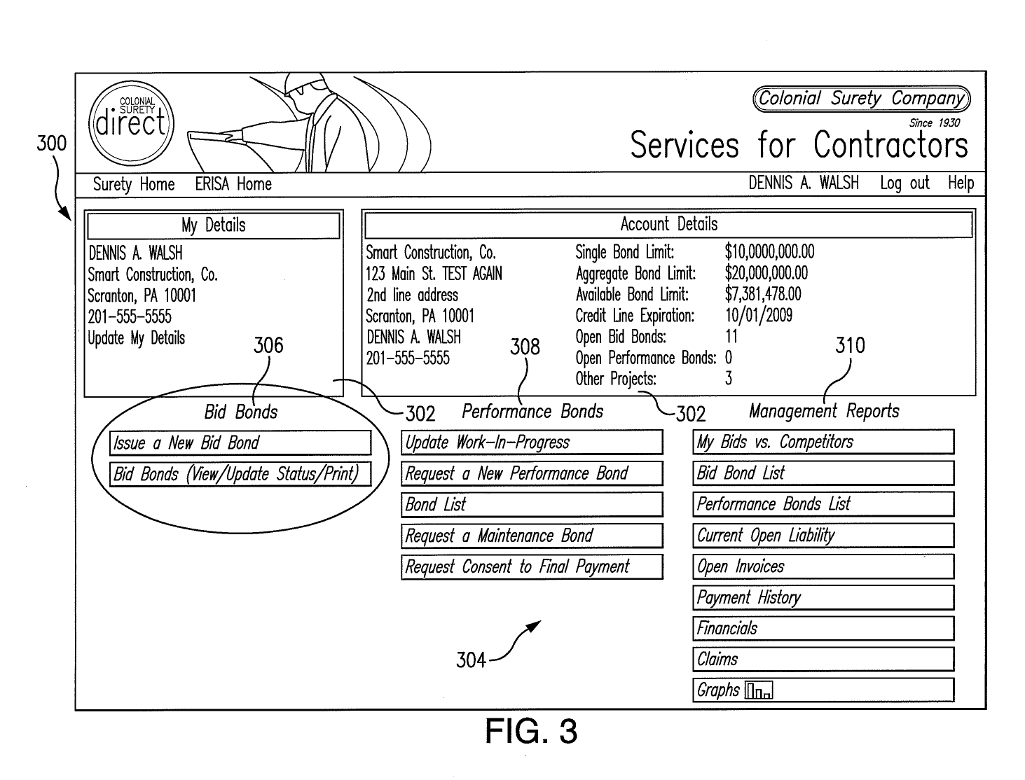

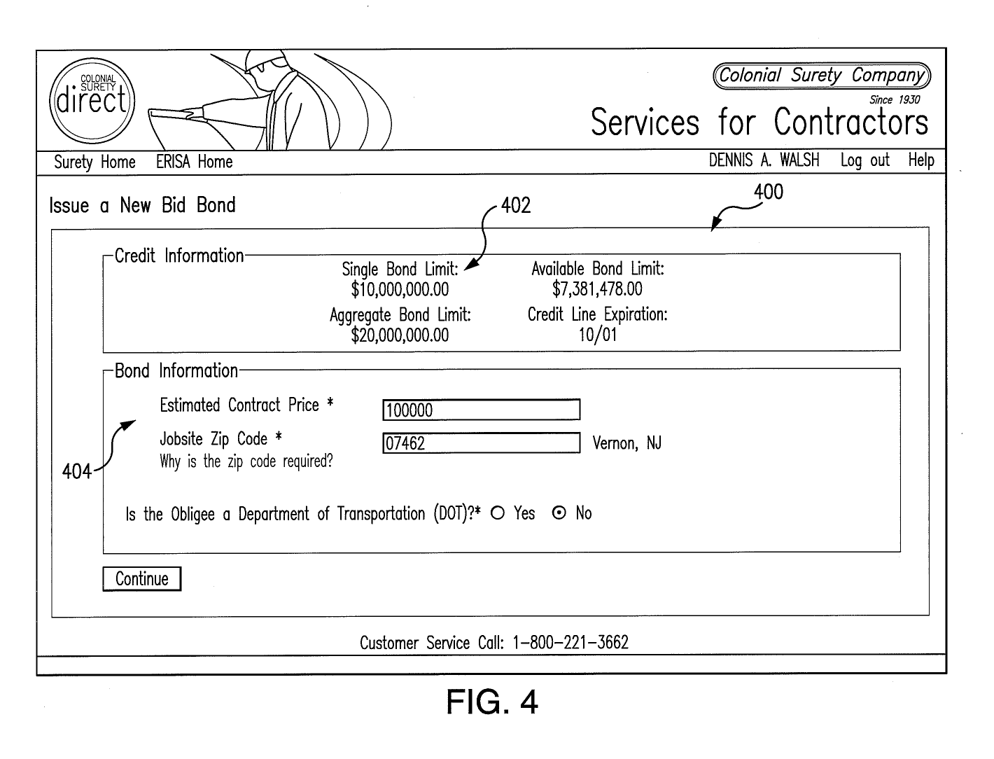

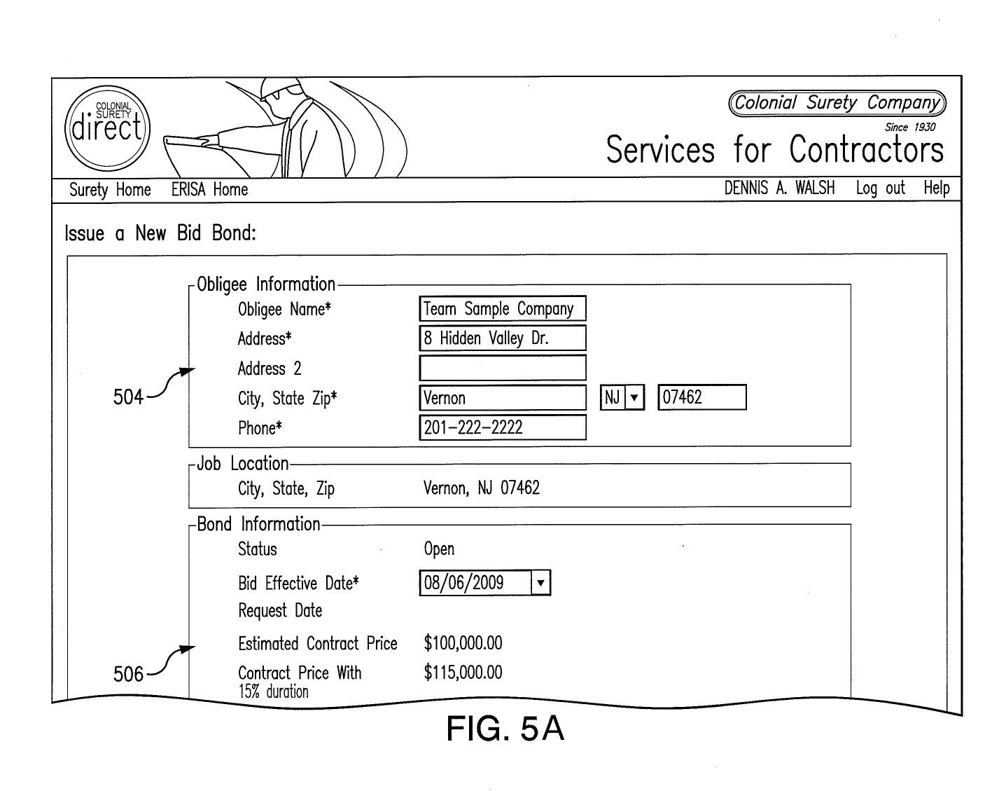

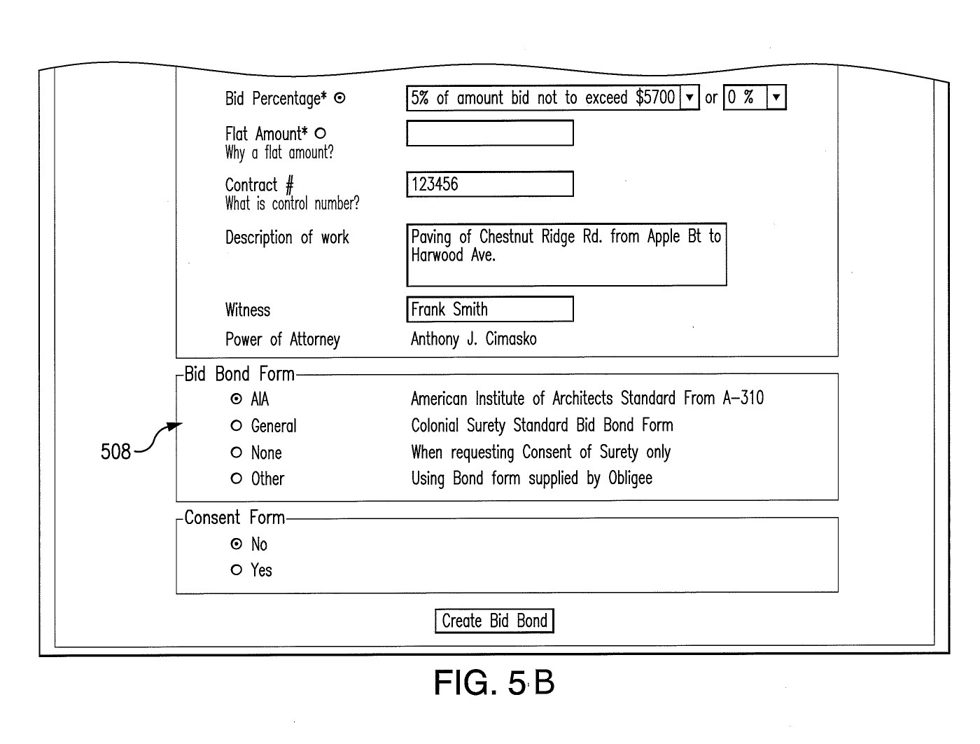

For instance, FIG. 2 depicts a welcome screen (200), which can be transmitted to an end user via network 120. Alternatively, this welcome screen (200) can be provided to the end-user via interface 110 or any other similar means. FIG. 3 depicts a home screen (300), which displays the end-user profile (302)—namely the profile of Dennis Walsh. In addition, the home screen (300) also provides menus (304) for further navigation options. These menus (304) include “Bid Bonds” (306), “Performance Bonds” (308), and “Management Reports” (310). FIG. 4 depicts a screen shot (400) for issuing a new bond (e.g., refer to “issue a new bond” under “Bid Bonds” (306) of FIG. 3) and provides current credit information (402) of the end-user, and further solicits new bond information (404). And FIG. 5 depicts a subsequent screen for issuing the new bond, and displays information such as Obligee information (502) and Bond information (504) and solicits bid information (506) and a particular bond form (508).

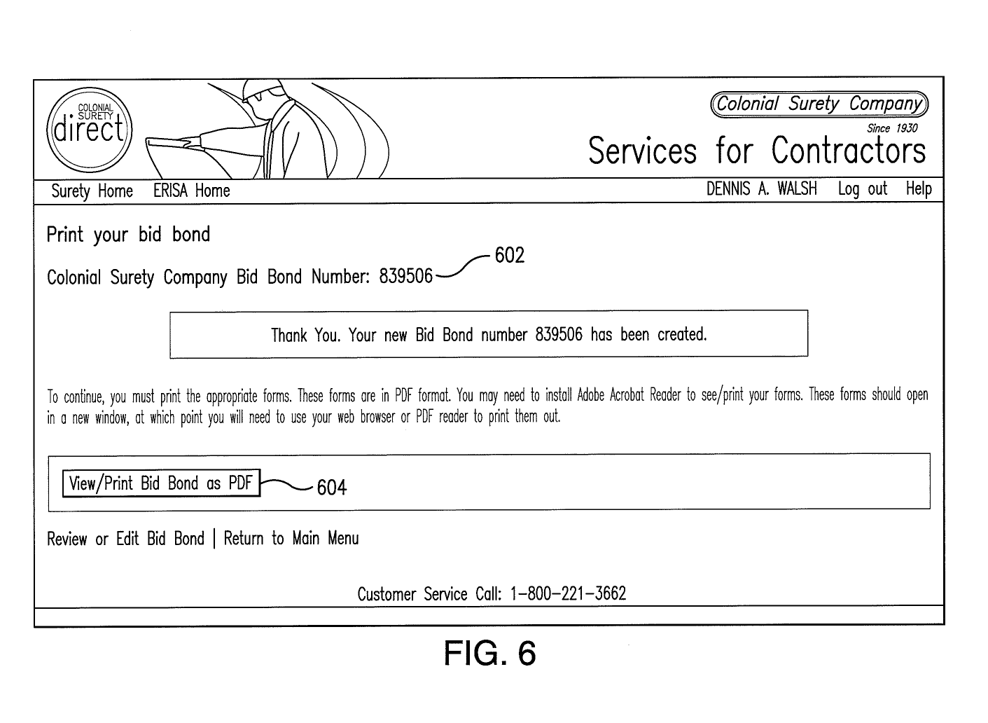

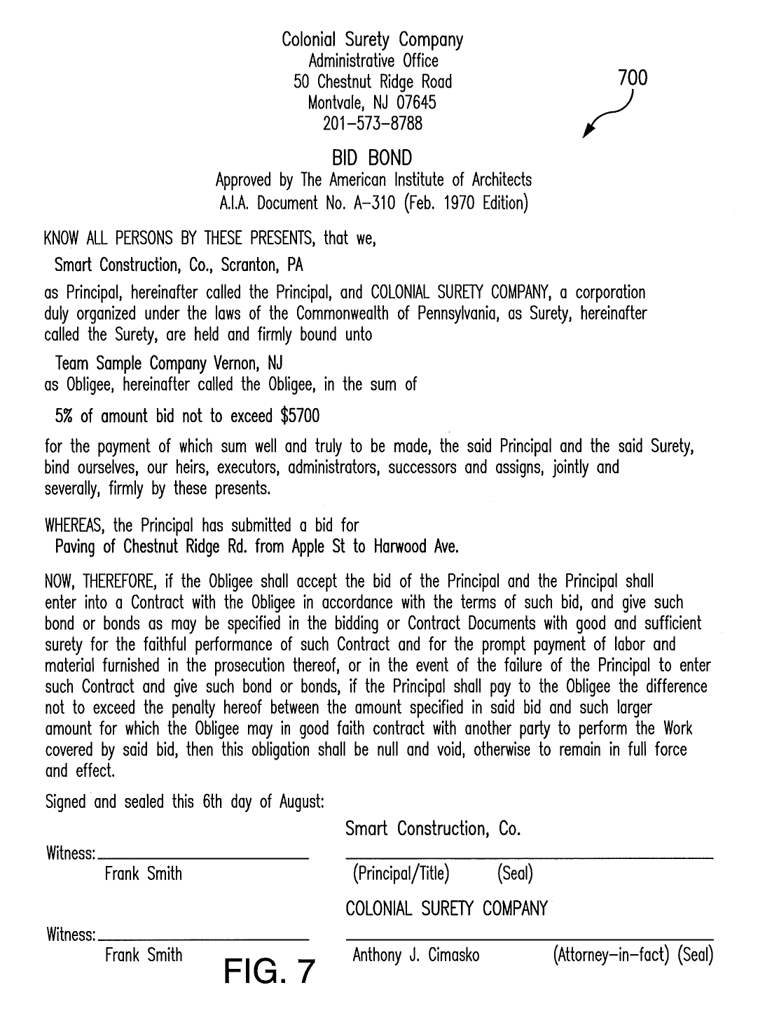

From the solicited input of FIGS. 4-5, system 100 is configured and operative such that a new bond is created and assigned a bond number (602), as depicted in FIG. 6. FIG. 6 further allows the end-user to view/print this new bond (604), as depicted in FIG. 7 (as indicated by reference numeral 700), which is an example of a Bid Bond (700) created from the solicited input from FIGS. 4-5. In accordance with an aspect of the invention, system 100 of FIG. 1A, uniquely processes and generates bid bonds online. That is, stepping through a progression of the computerized steps illustrated in FIGS. 4-7 and as enabled by system 100, and with reference to FIG. 1B, the end-user inputs into system 100 application information regarding a bid bond (step 40). Such information includes, but is not limited to: obligee information (502), bond information (504) bid information (506) and requested bond form (508). The system 100 is then configured and operative to validate this information using internal system processes including, but not limited to, background and credit checks (step 42). It is to be understood and appreciated system 100 enables the end-user applicant to make any changes instantly, via amending or editing input information online (step 44). After the end-user applicant's information is validated by system 100 (step 42), system 100 in real-time, and on-line, generates the bid bond (step 46) (FIG. 7), which the client can print directly for a client printing device.

With regards to the aforementioned validation, the account details (302) on the home page (300) (FIG. 3) preferably contains information that validates the issuing of a new bid bond. System 100 is configured and operative such that the application information is updated in real-time and the client can drill down to the details to view how all the amounts are derived by system 100. It is to be understood the credit line expiration date, single limit and aggregate limit are determined by the system 100 (in compliance with underwriters regulations) based on the clients finances. For instance, system 100 applies the following parameters to the below illustrated bond:
Single Bond Limit: Client cannot issue a single bid bond for more than $4,500,000.
Aggregate Bond Limit: The sum of all new, open and awarded bid bonds cannot exceed $20,000,000.
Available Bond Limit: The aggregate limit less any open and awarded bid bonds.
Credit Line Expiration Date: The current date must not exceed the line expiration date.

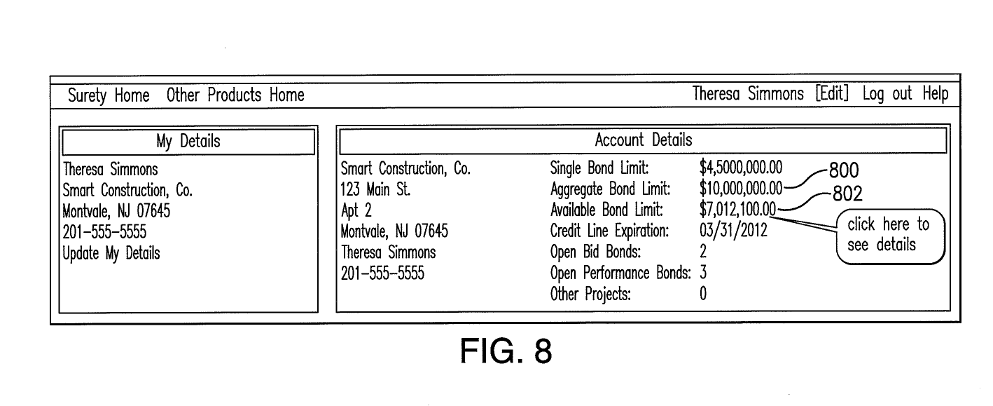

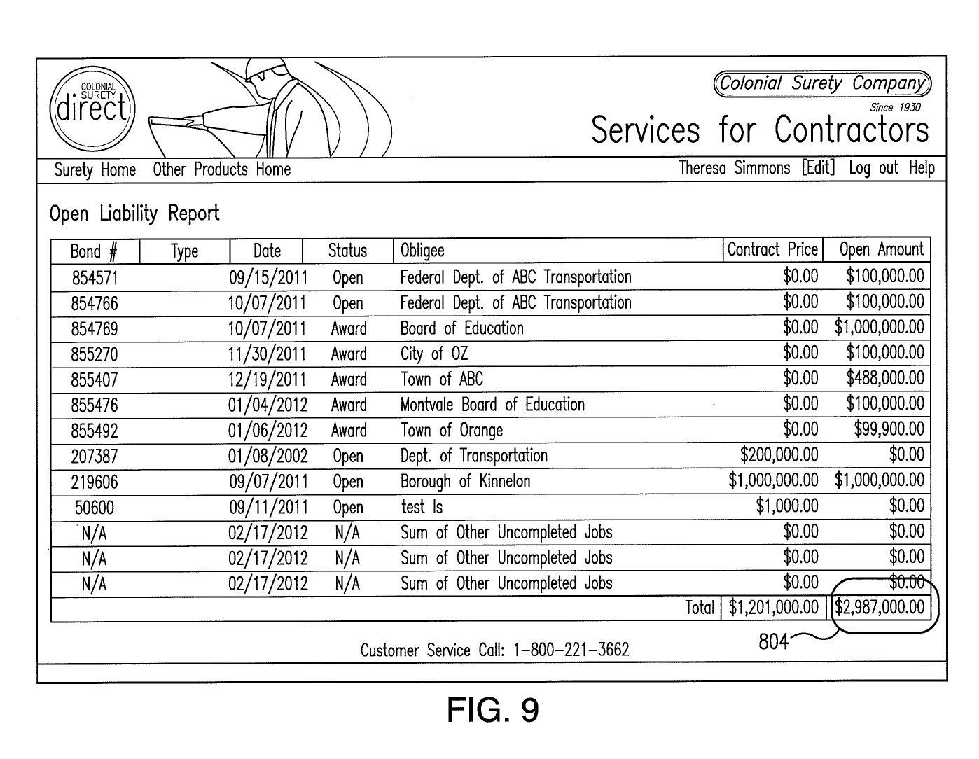

Further, and with reference to the illustrated screen shot of FIG. 8, system 100 is configured and operative to enable a client to click the link (i.e., Available Bond Limit: $7,012,100.00) to view details (900) (as illustrated in the screen shot of FIG. 9) regarding the available bond limit (802). System 100 is configured and operative such that the available bond limit (802) changes in real-time when open amounts become closed. For instance, and with reference to FIG. 8, the aggregate bond credit limit of $10,000,000 (800) minus the open amount of $2,987,900 (804) (FIG. 9) equals the available limit of $7,012,100 (802). It is to be understood that in the prior art this type of information was not available in real-time to a client that issues bid bonds and performance through a broker.

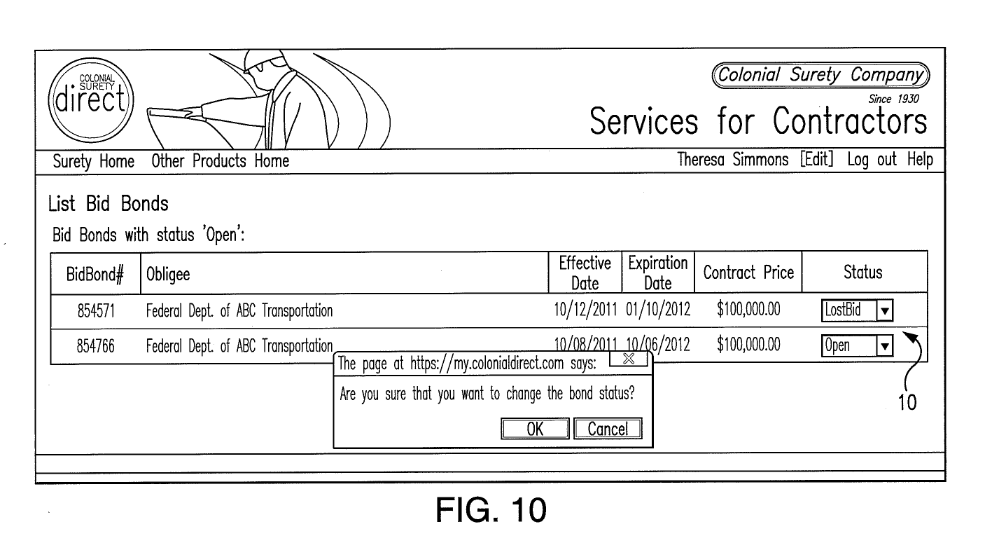

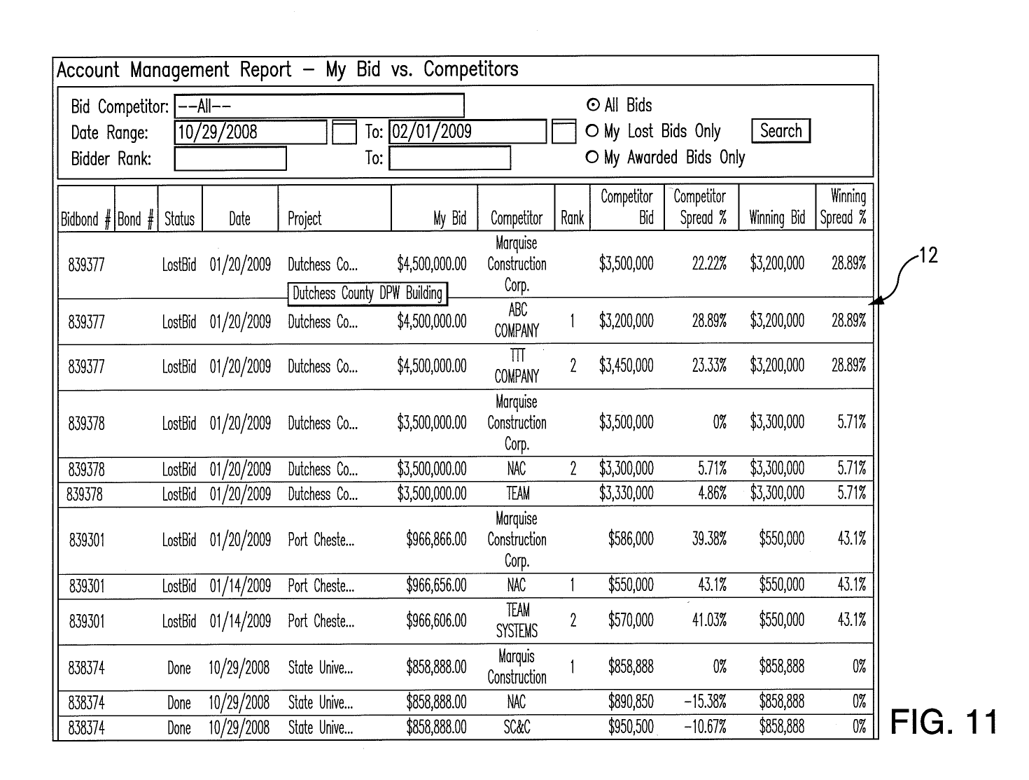

It is to be appreciated in some embodiments, a credit line of the end-user can be automatically adjusted. For example, and with reference to the illustrated screen shot of FIG. 10, when a bid bond status is updated from “open” to “lost” (10), the system 100 is configured and operative to automatically increase the credit line so the end-user can bid again with new, e.g., higher, limits. This type of automatic adjustment option can be accessed from the “Bid Bonds” menu (300) (FIG. 3), and more specifically, via the “Bid Bonds (View/Update Status/Print) selection.

Description is now provided in regards to an illustrative example of how a credit line is adjusted by system 100. For instance, and with reference to FIG. 1C, a credit line for a bond is preferably adjusted as follows: the system 100 (e.g., the underwriter) increases or decreases the single and/or aggregate credits limit based upon financial underwriting review (step 48). Next, the Bid bond status is changed in the system 100 to reflect its current status (e.g., “Done/Completed”, “Cancel” or “LostBid” (step 50). The amount of the bid bond now becomes available to the client (step 52). The system 100 then preferably updates the contract bond open liability as the job reaches various stages of completion, as reported by the client (step 54). For example, a $100,000 job that is 75% complete has an open liability of $25,000. Thus, the system 100 provides an update such that the $75,000 becomes part of the clients available credit line to be used when creating another bid bond.

With returning reference now to FIG. 3, and the menu titled “Management Reports” (310), system 100 formats the aforesaid management reports to provide real-time information regarding certain aspects of the end-user's bid bonds, performance bonds, payment history, claims, and open liability. In this regard, reference is now made to FIG. 11 which illustrates an exemplary management report (12). As illustrated, a management report (12) combines many types of information preferably including bidding results, bid bond history, performance bonds history, client financial statements and other work projects unrelated to the underwriter. The bidding results, other projects, and financial information are preferably provided by the client. This information is preferably coalesced and presented to the client for useful purposes. It is noted that an advantage of this coalesced information by system 100 is a client is enabled to analyze the data to enable them to strategize their bidding more effectively and competitively in the market. It is to be understood, the data is typically fluid and changes real-time and as such, the client is viewing the most current information.

It is to be appreciated the aforesaid bidding analysis is a unique report generated by system 100, which is not available by any other underwriting service. In one illustrated embodiment, it compares the client's bidding results to a competitors and an engineer's estimate. The bidding comparison percentages allow the client to perform an in depth analysis of their competitor's bidding history.

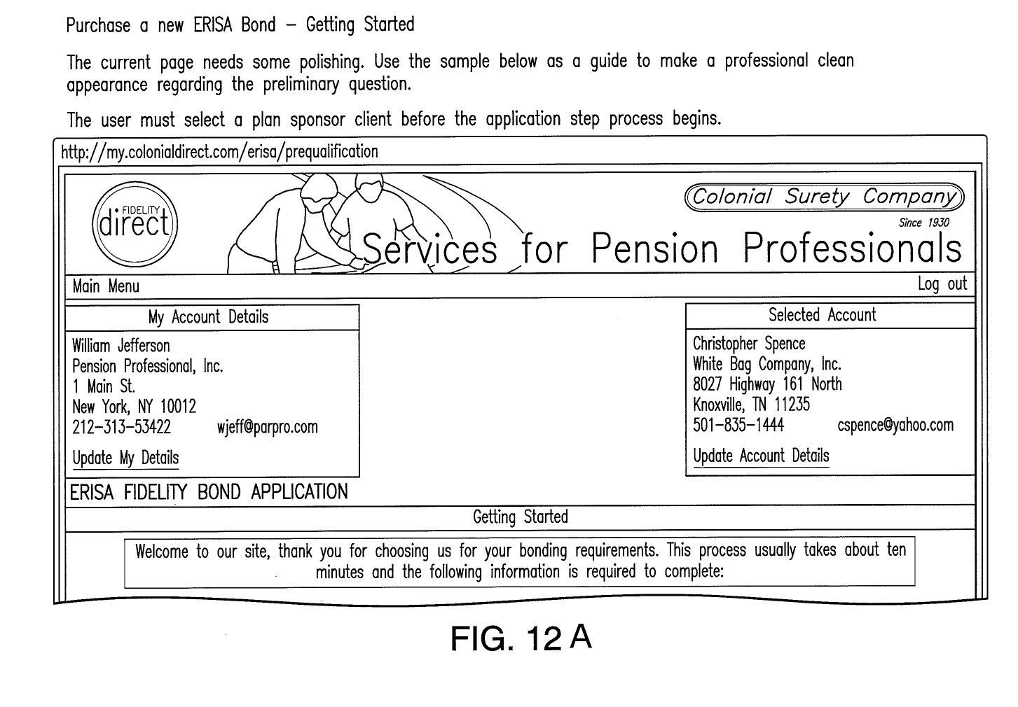

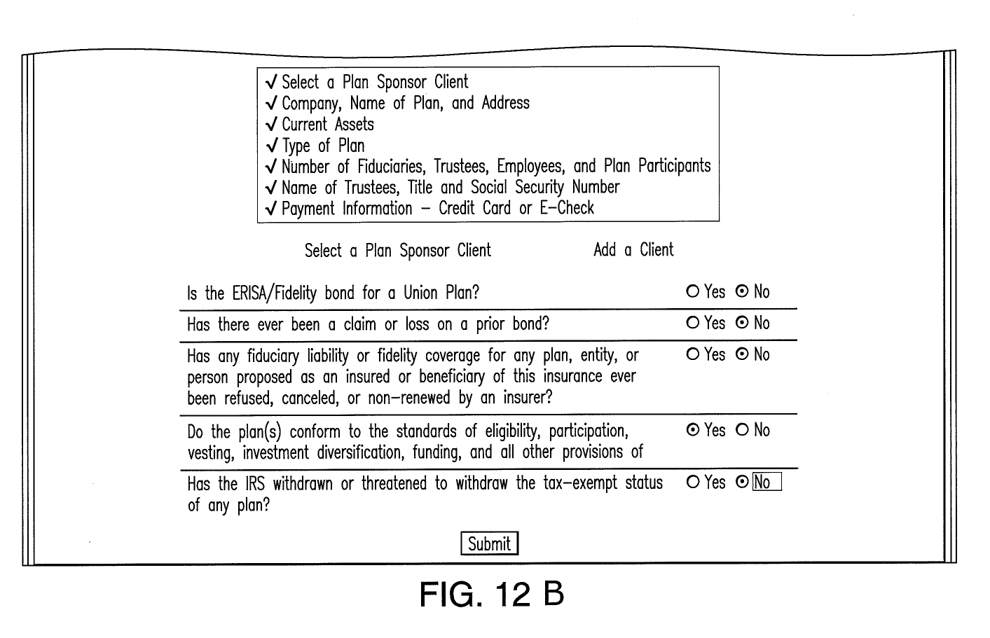

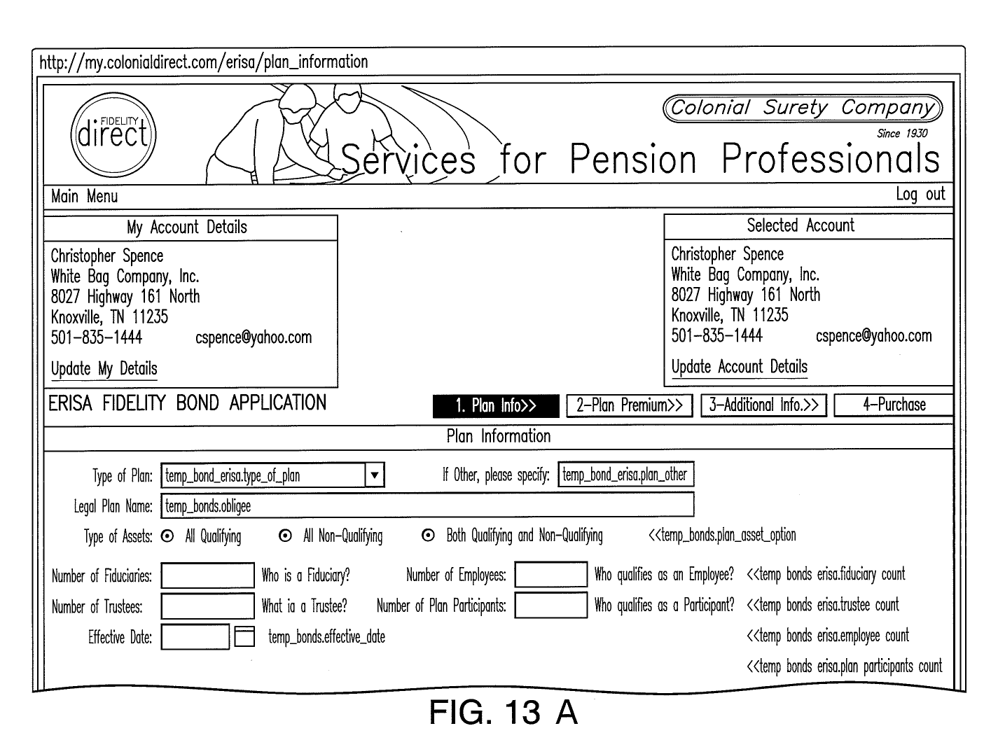

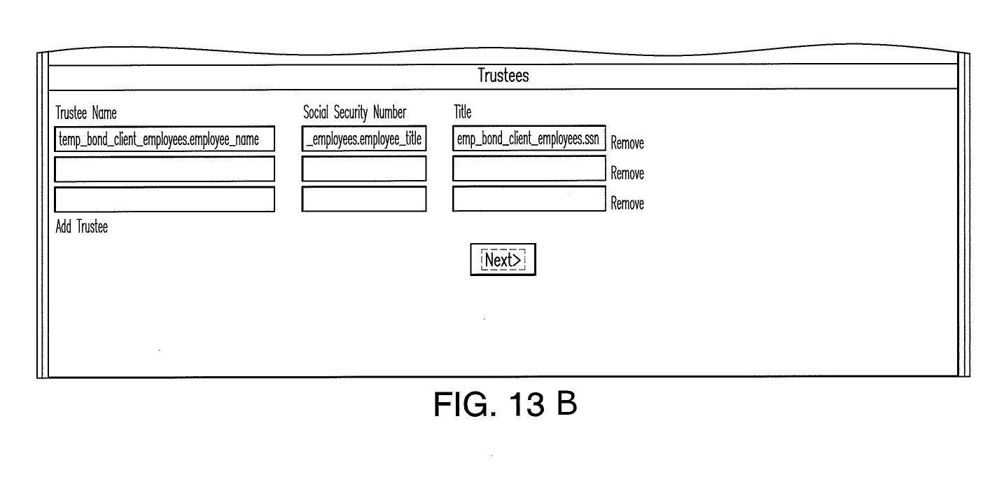

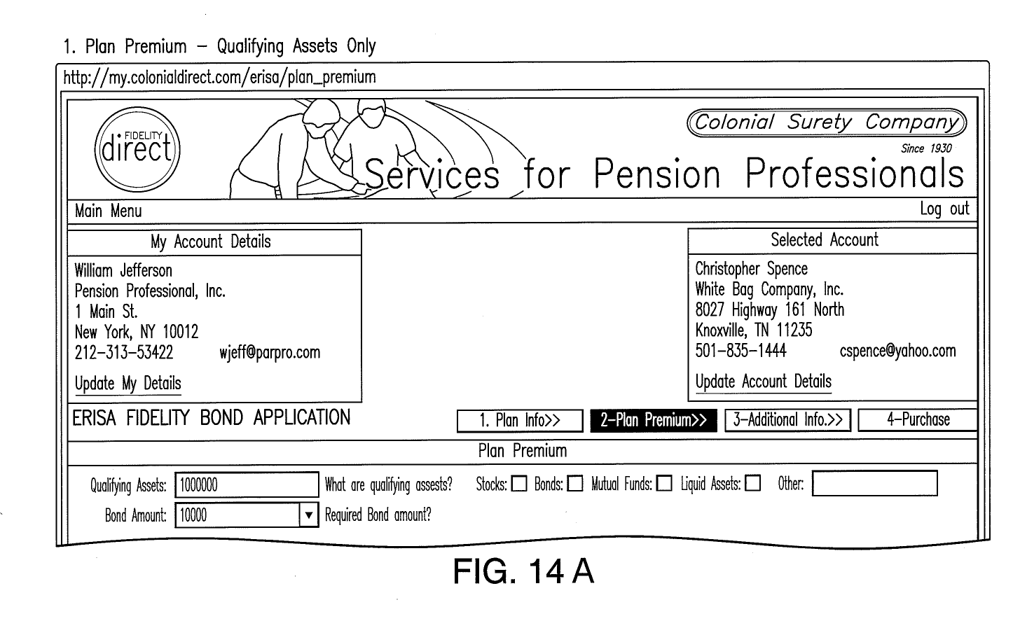

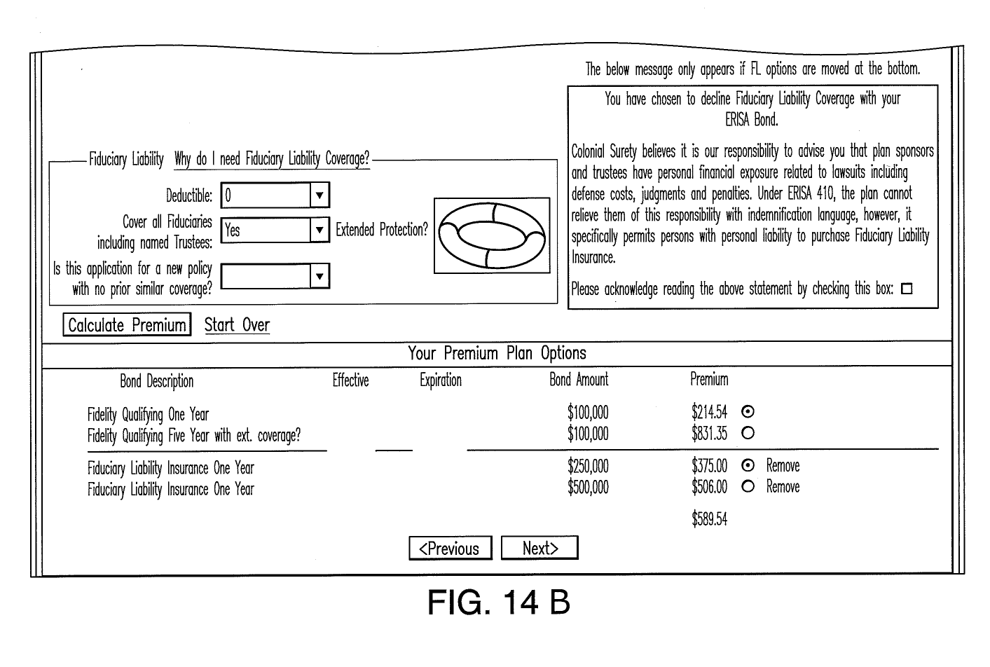

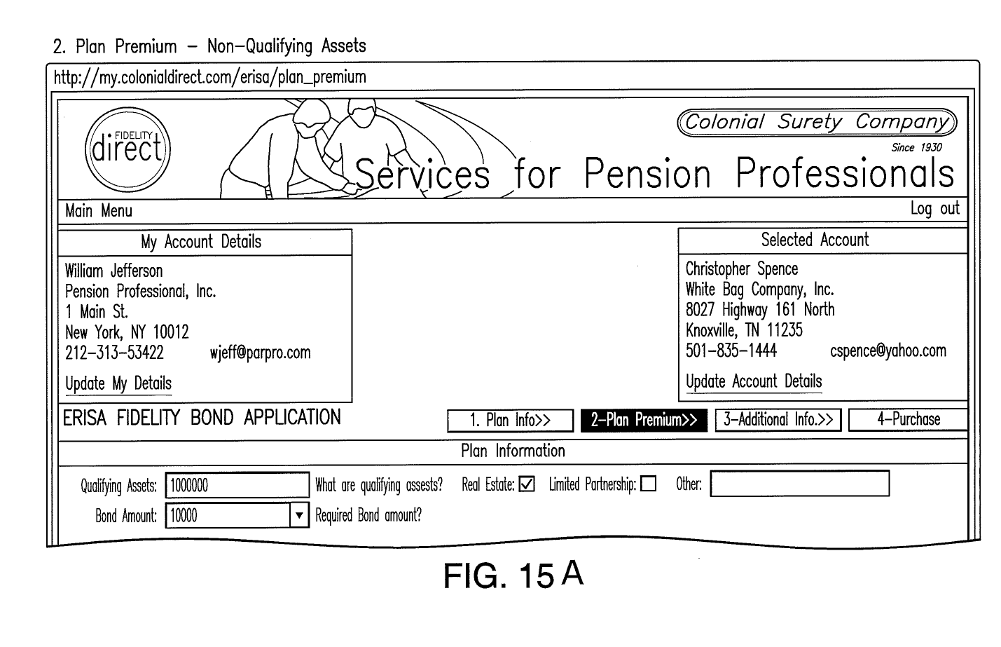

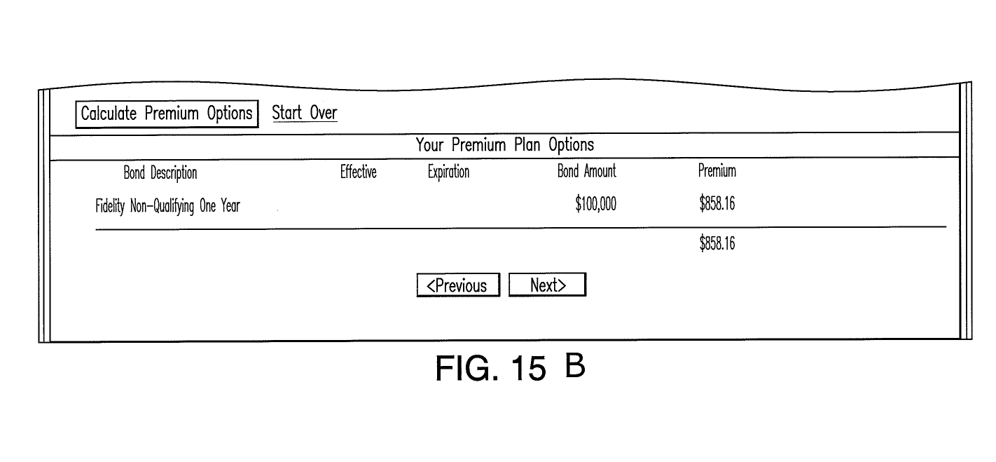

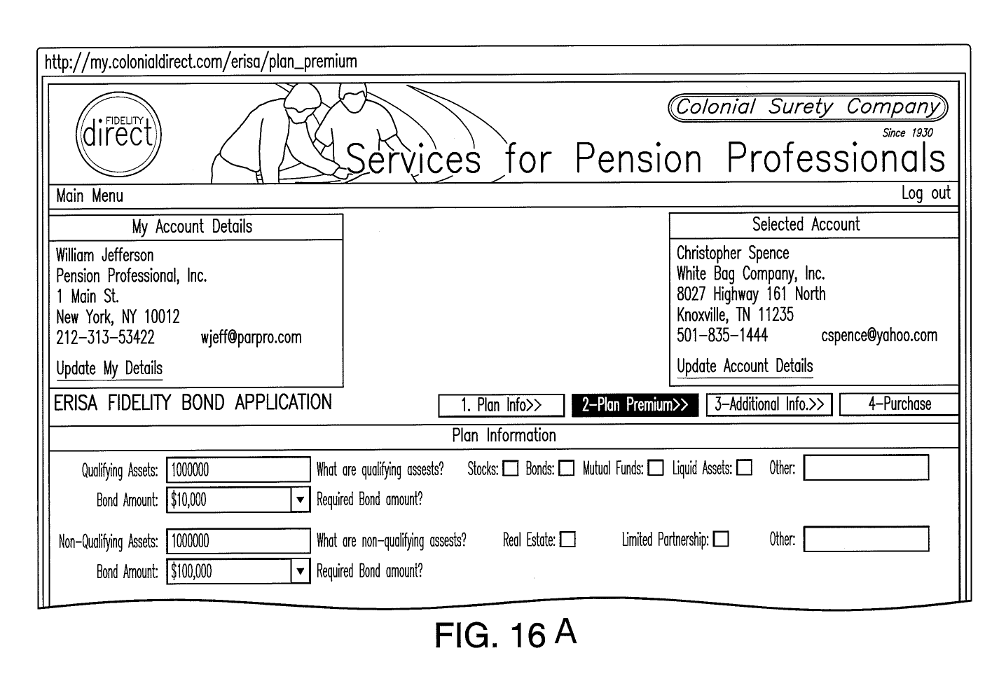

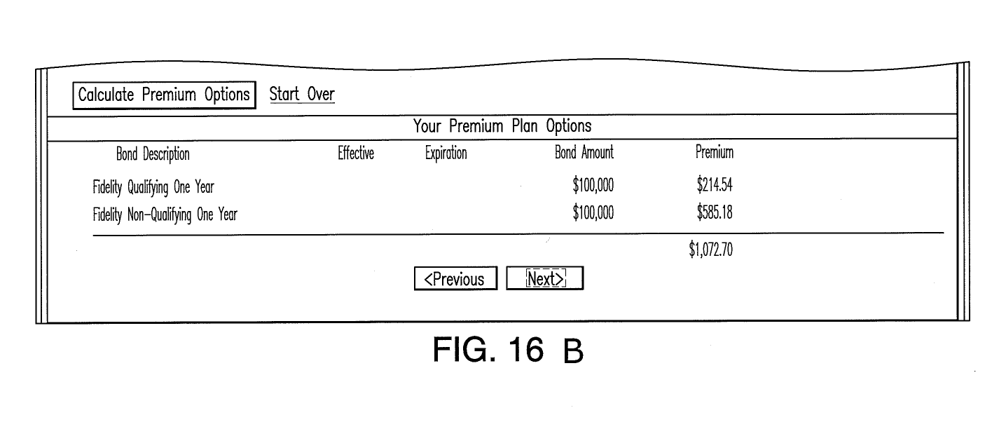

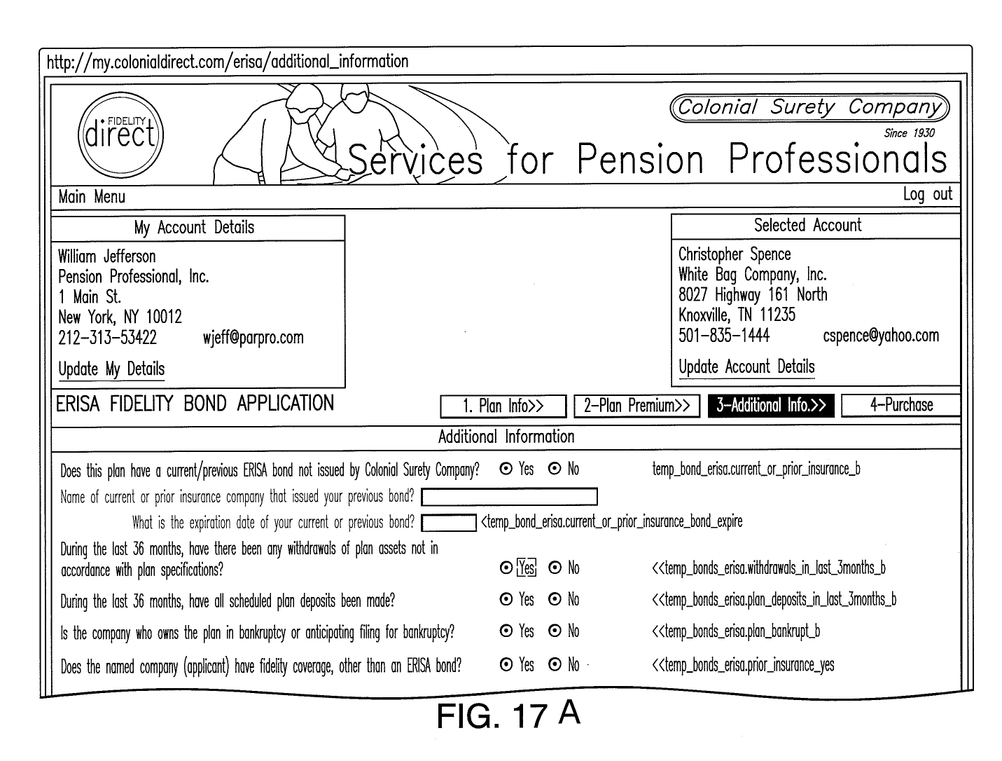

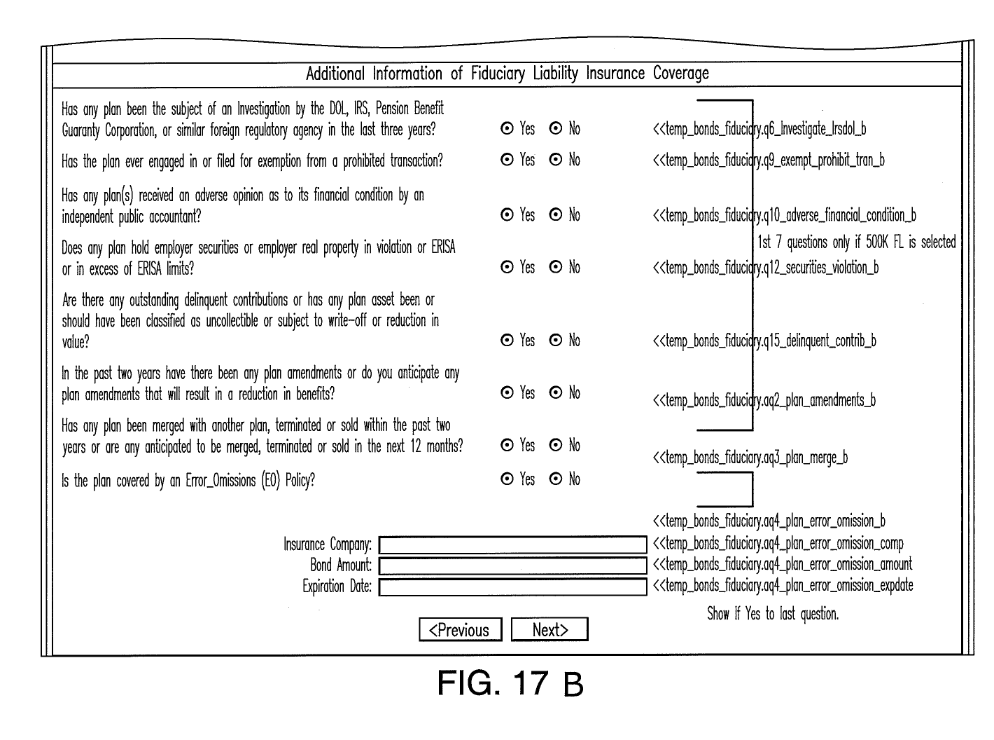

With reference now to FIGS. 12-17, illustrated are various screen shots of embodiments generated by system 100 for Employee Retirement Income Security Act (ERISA) bonds purchase process and improvements directed thereto. In particular, FIG. 12 provides an initial welcome page whereby the end-user must select a plan sponsor client prior to soliciting further application information. For example, FIG. 12 provides a set of questions for the end-user to select preferably via radio buttons. After proper selections, the end-user preferably begins an application for an ERISA bond. Remaining FIGS. 13-17 depict various screen shots of various input information the end-user provides to system 100 in regards to a bond application.

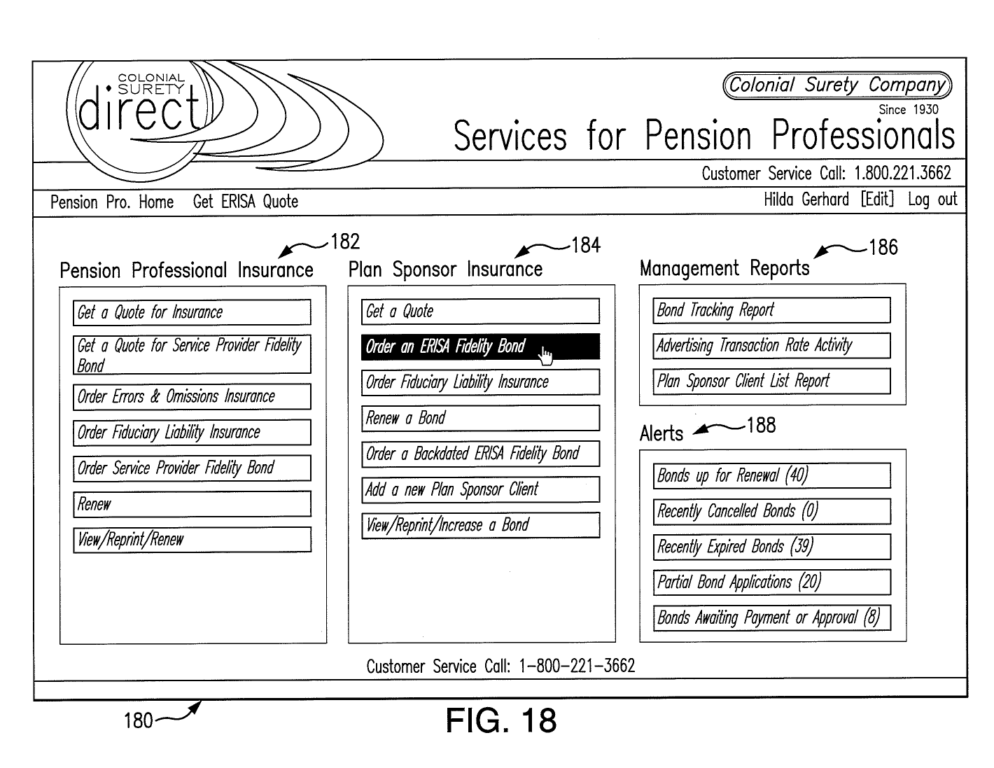

With reference now to FIG. 18, depicted is a screen shot (180) generated by system 100 of a pension professional website. As illustrated, website (180) provides various menu options for an end-user to select, including pension professional insurance (182), plan sponsor insurance (184), management reports (186), and various alerts (188). It is to be understood and appreciated management reports (186) and alerts (188) provide for improved management and organization of the end-user's bond portfolio. For example, the management reports and alerts can further, as generated by system 100, preferably include renewal alerts, information regarding recently cancelled bonds, information regarding recently expired bonds, information regarding applications in progress, and information regarding bonds awaiting a paper check payment.

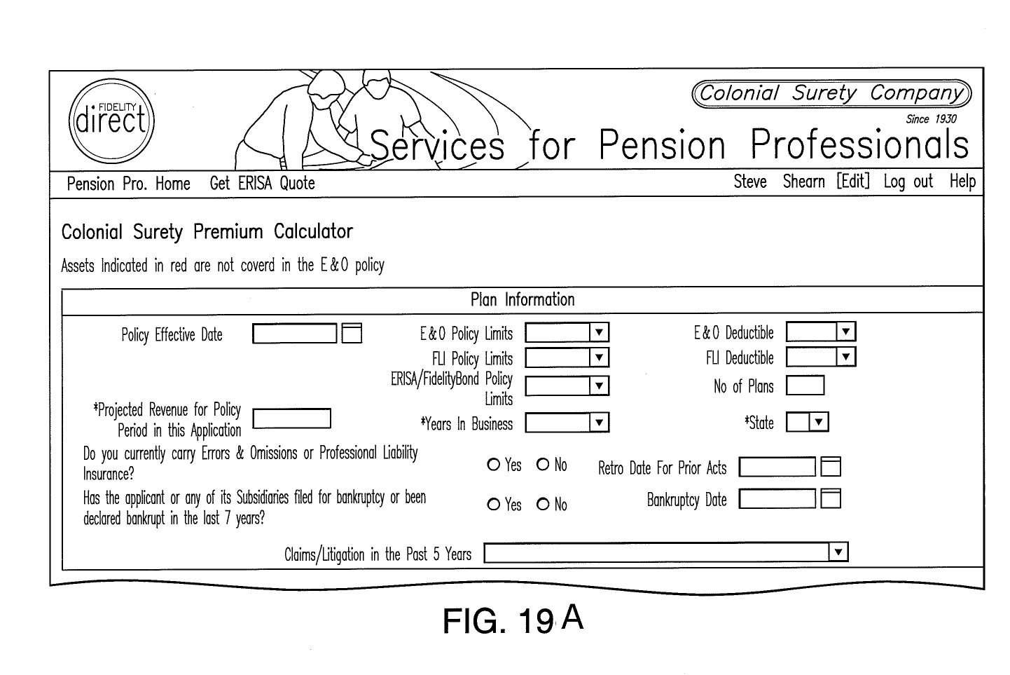

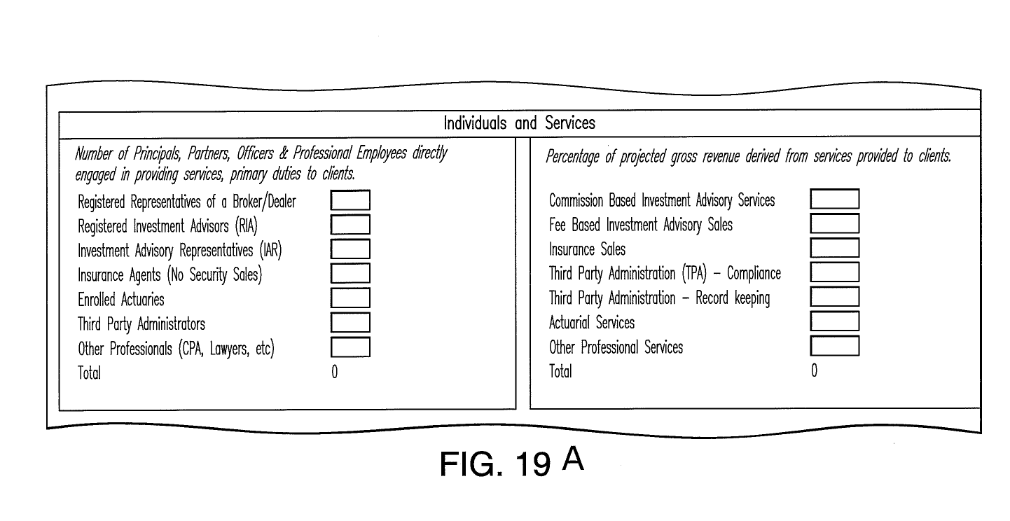

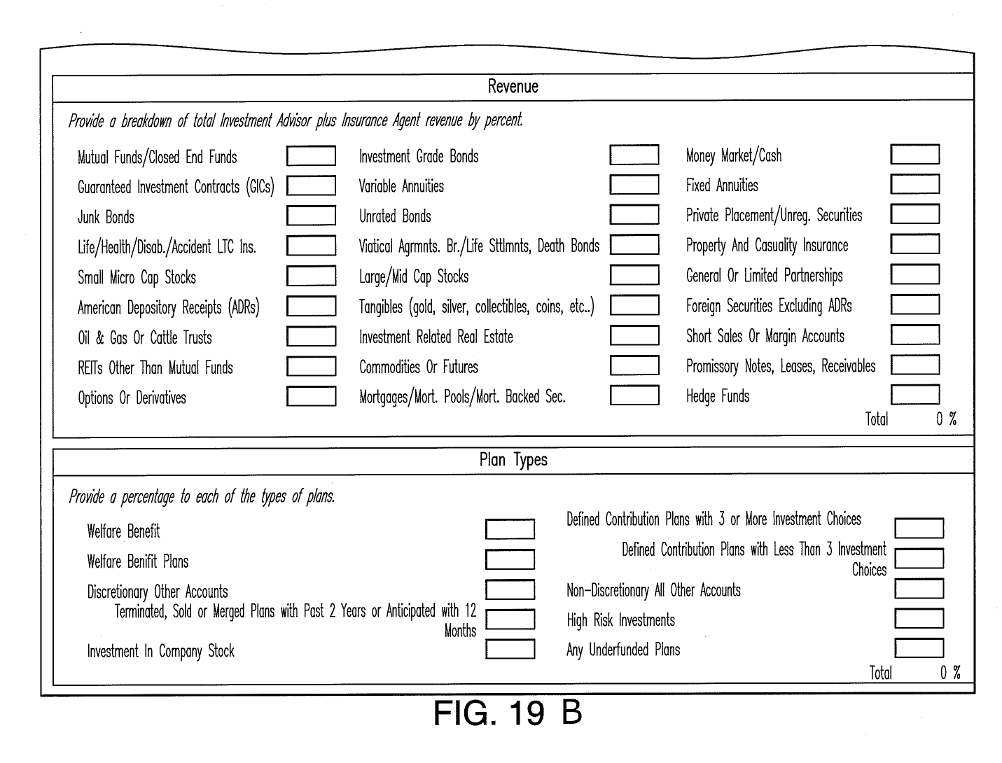

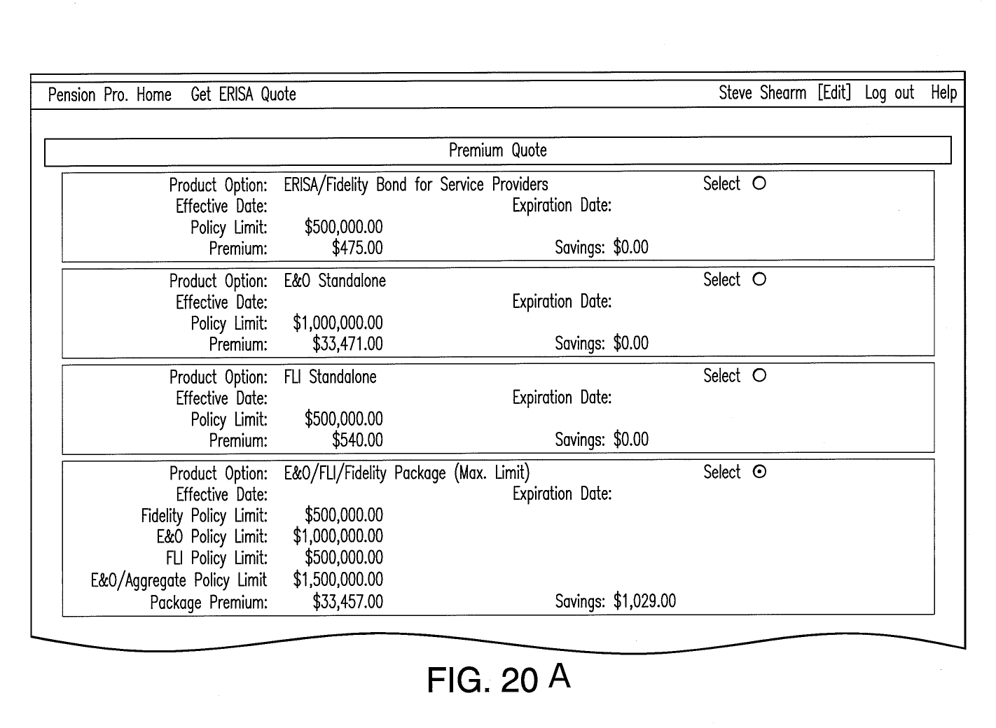

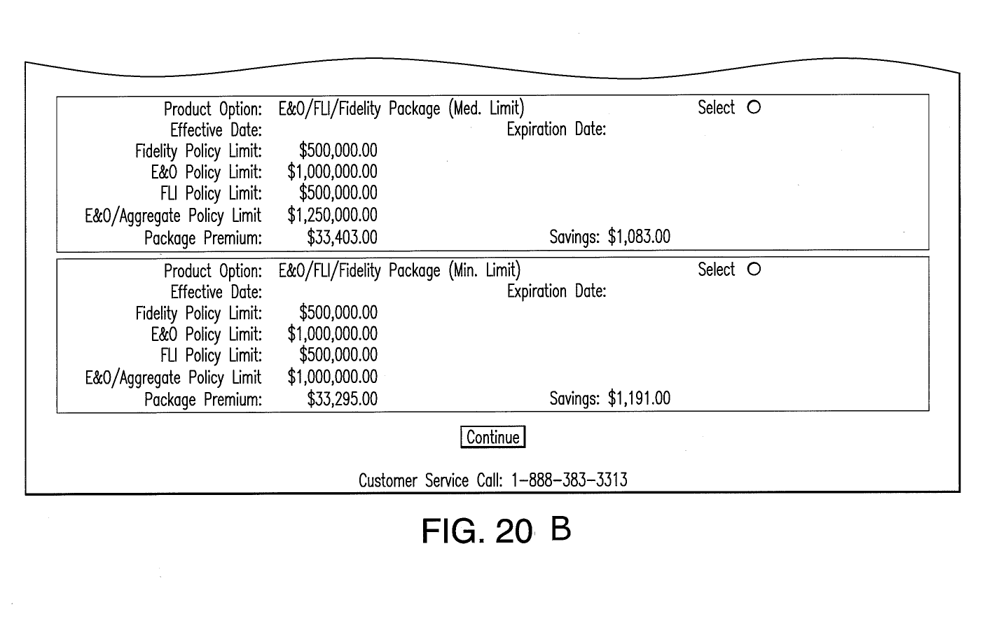

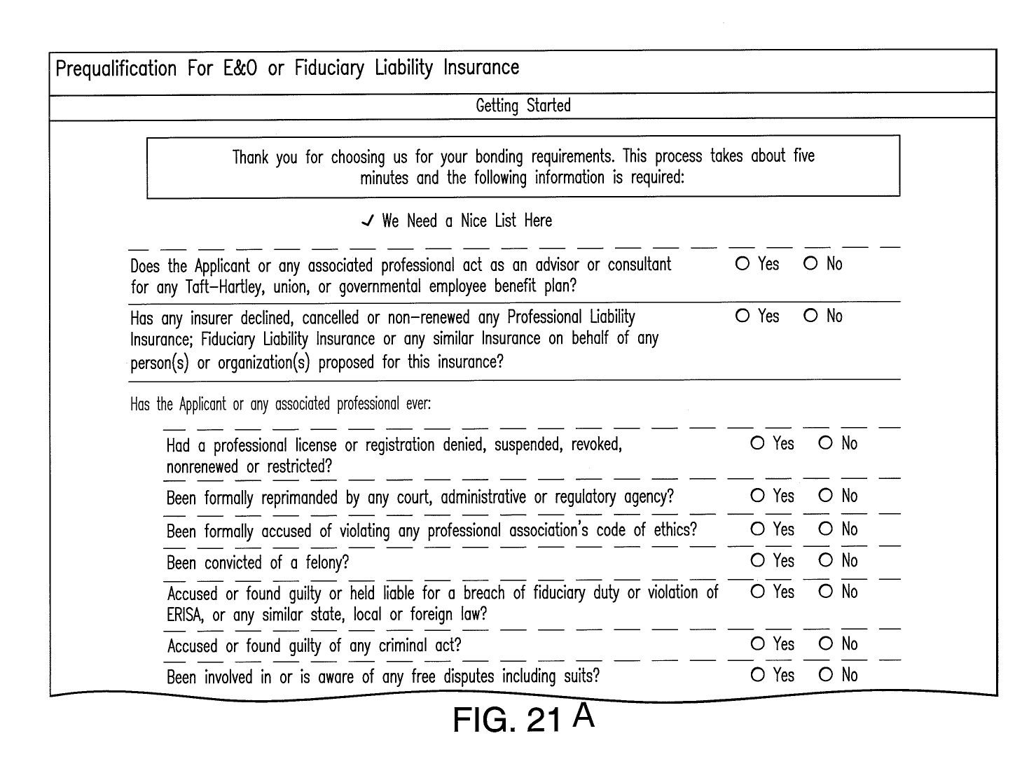

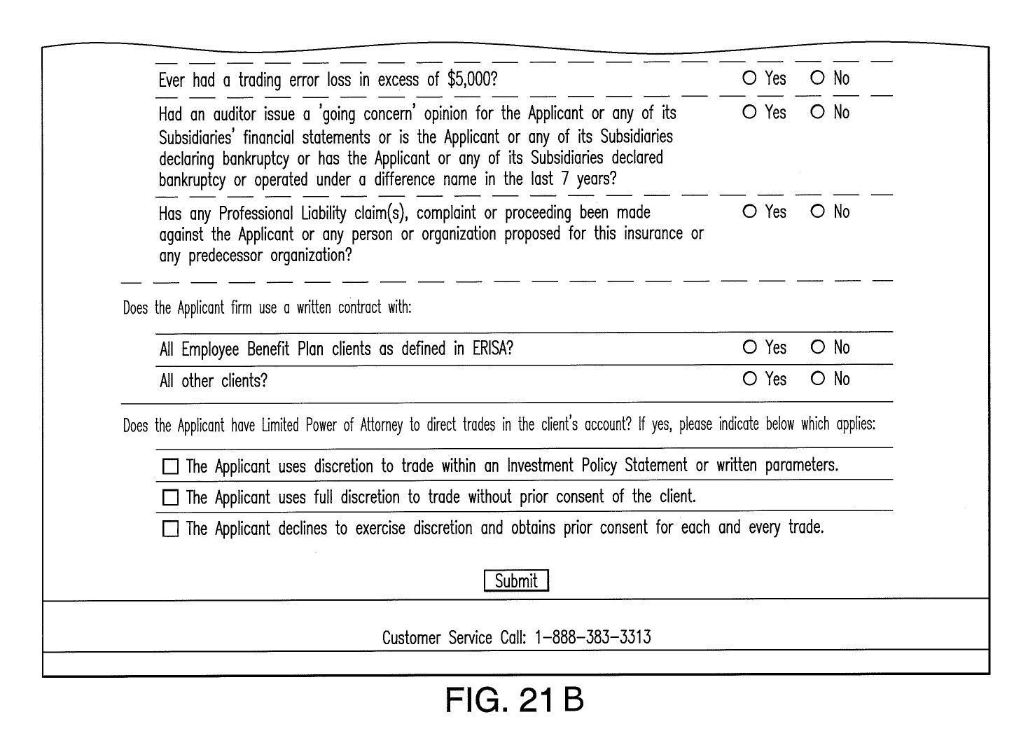

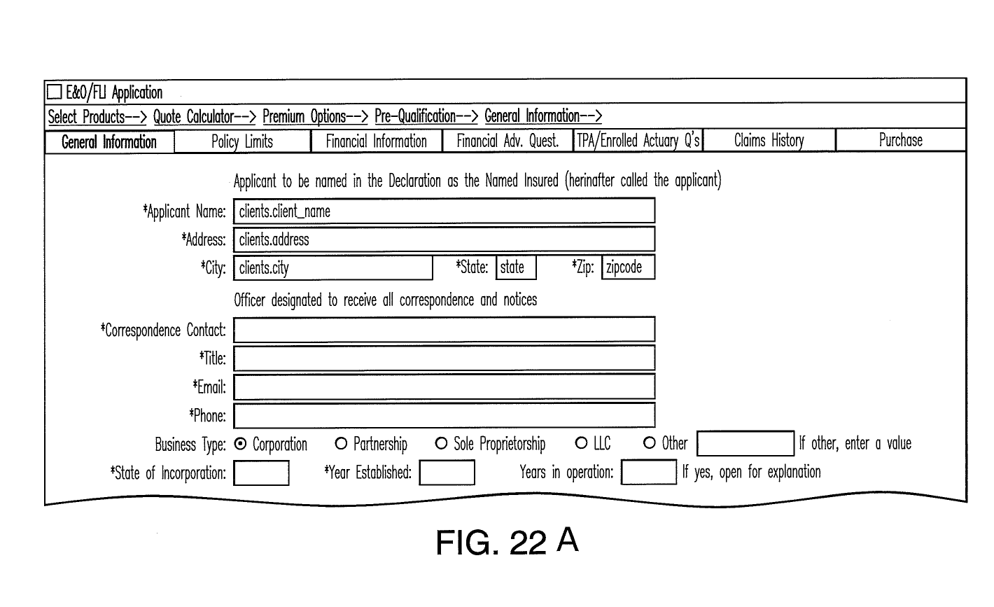

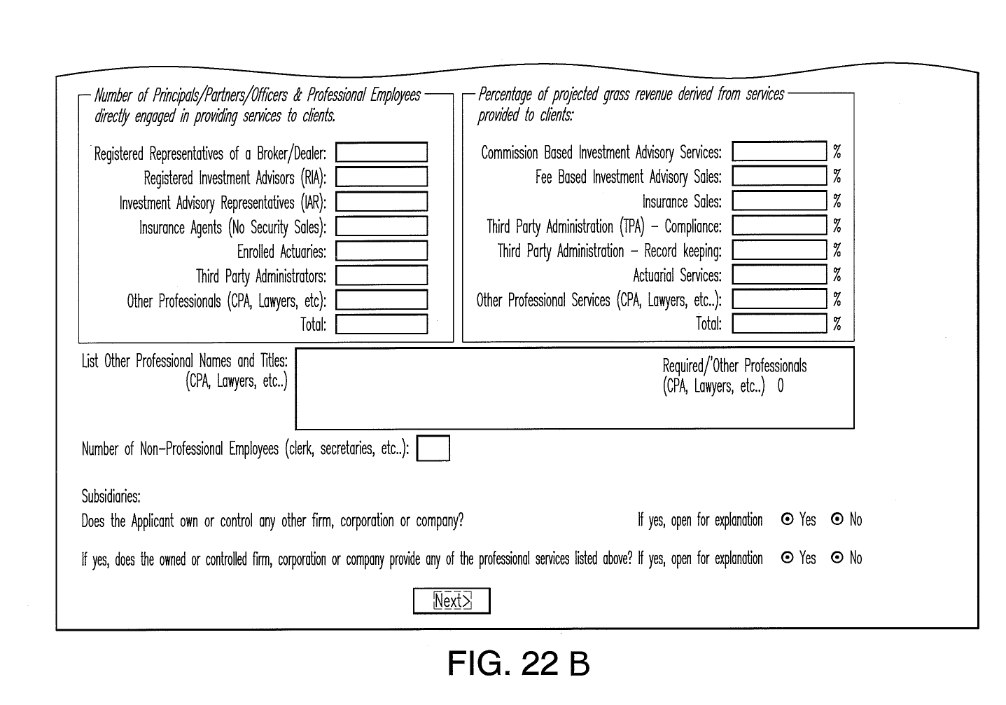

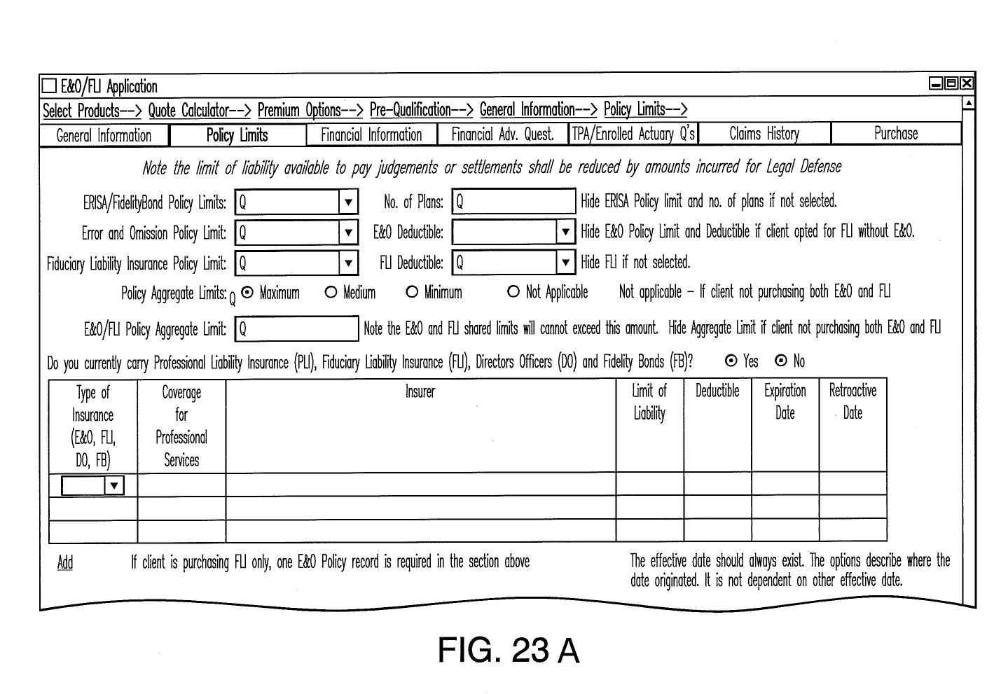

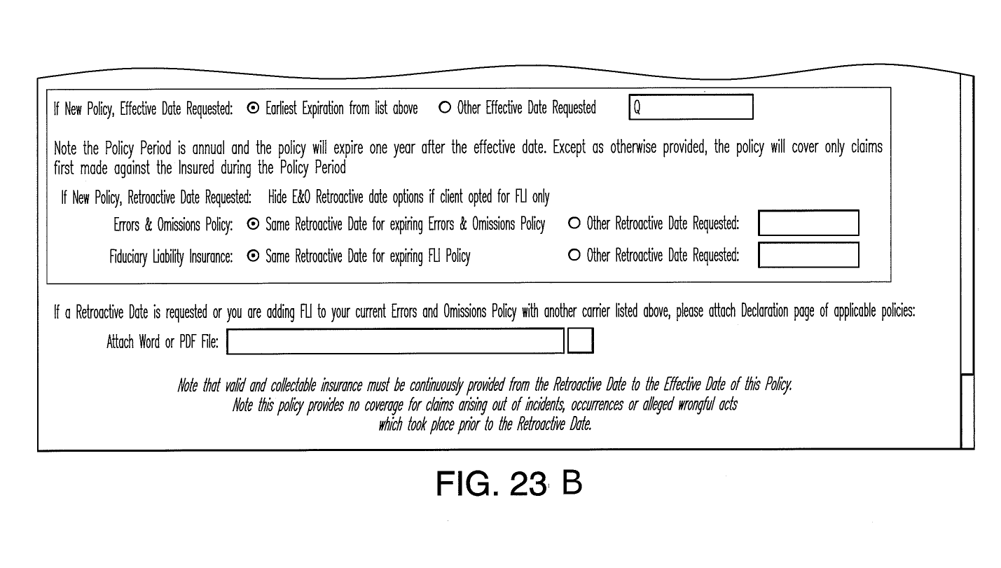

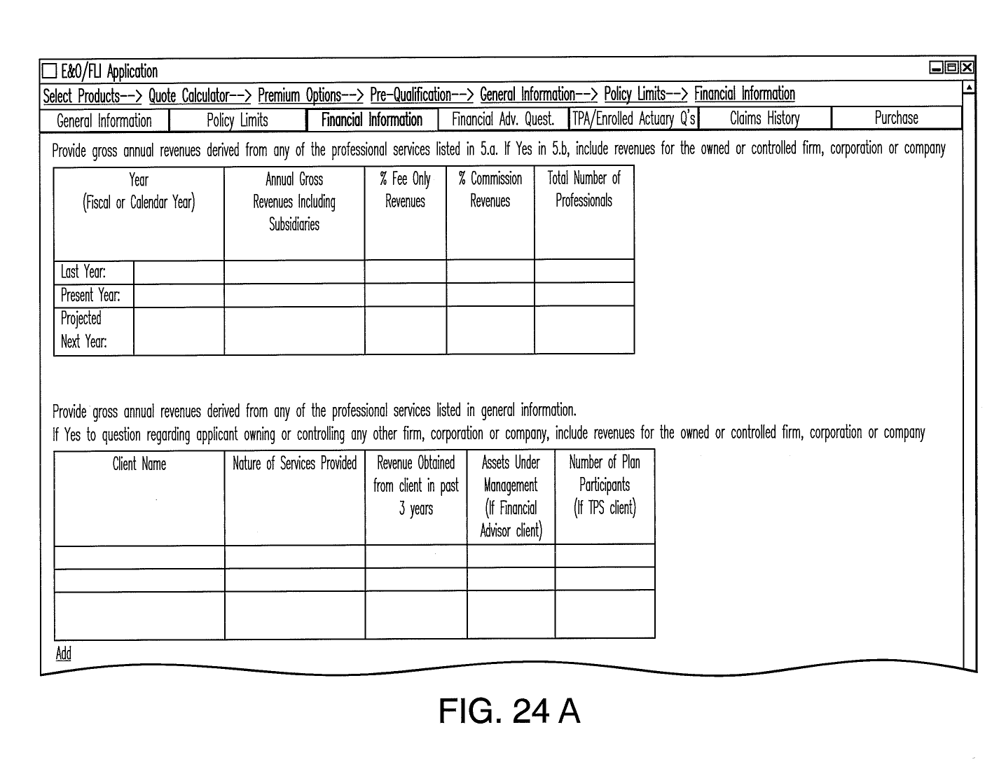

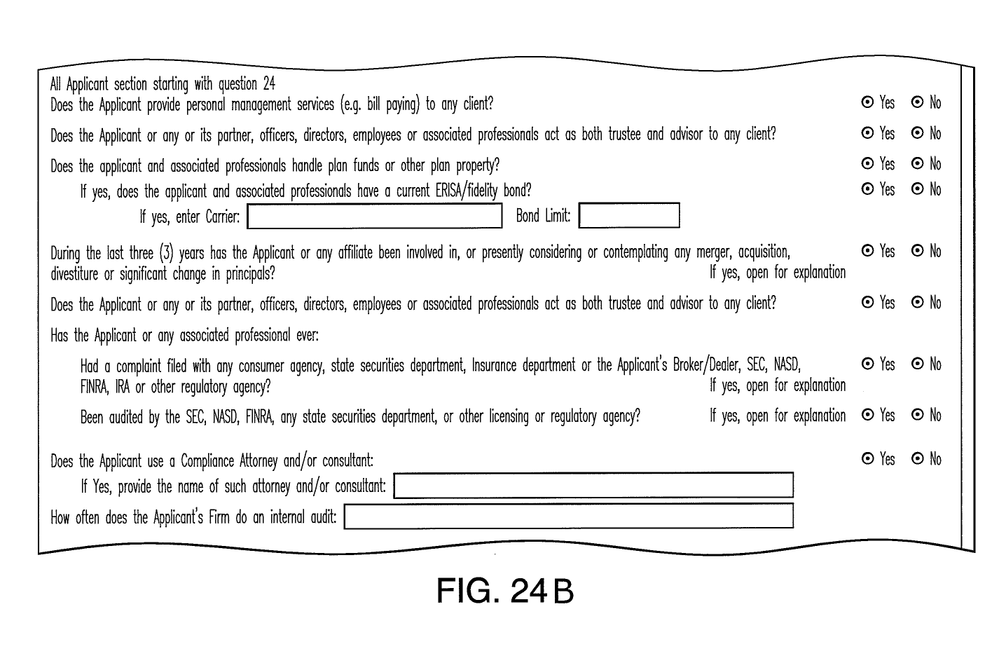

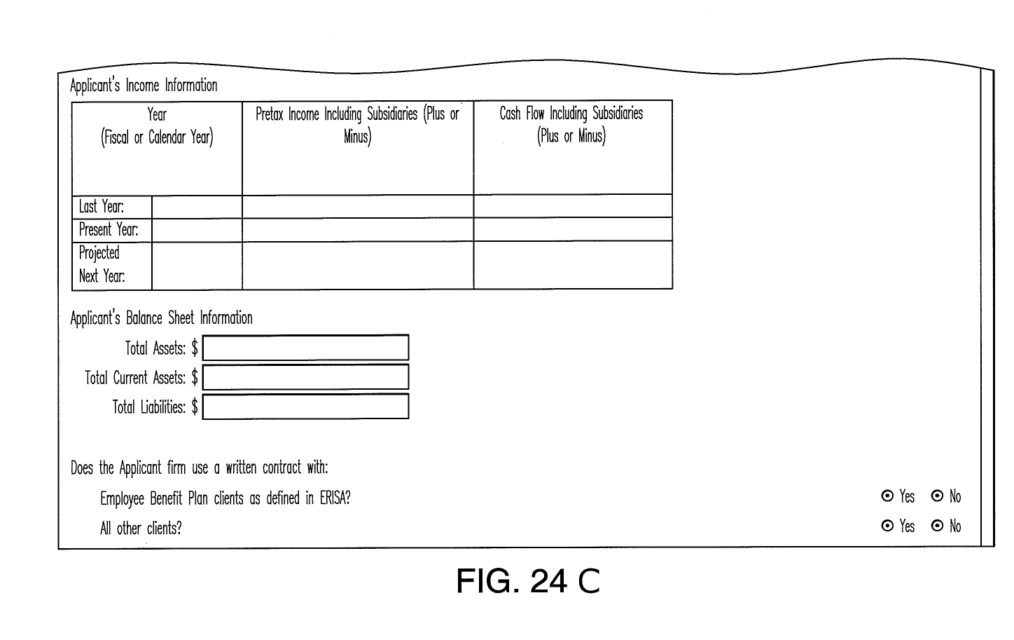

With reference now to FIGS. 19-24, depicted are various illustrative screen shots of embodiments for an interactive bond purchase management process that can be executed using system 100. In particular, FIGS. 19-24 depict various steps in a computerized bond purchase applications via system 100.

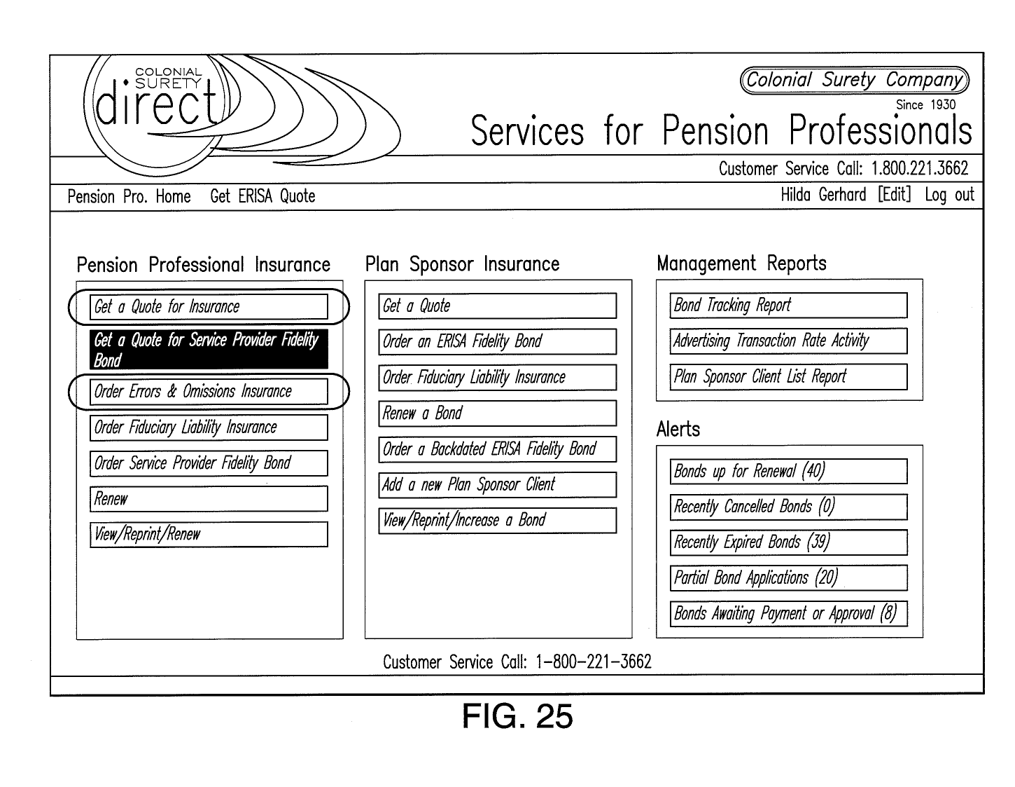

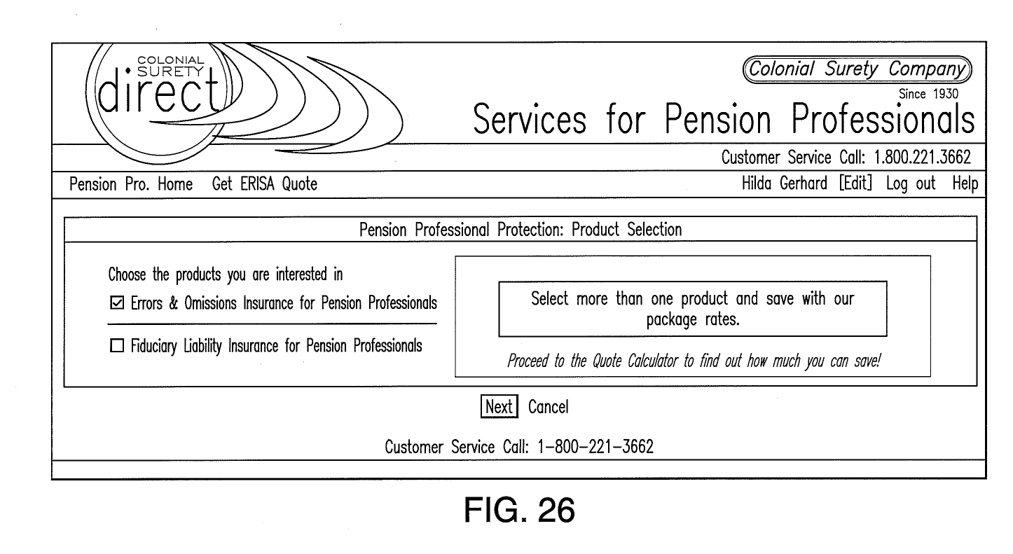

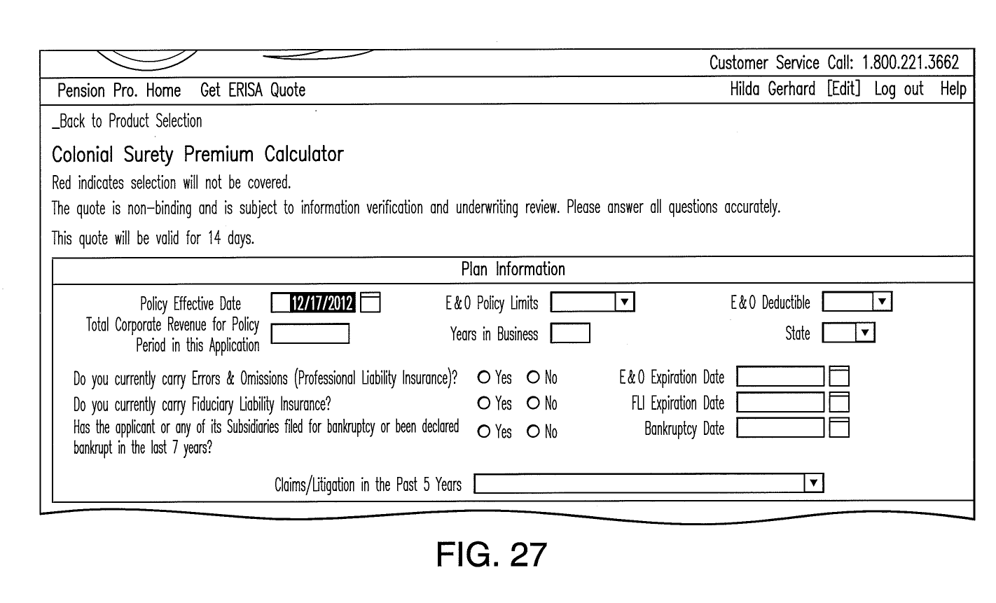

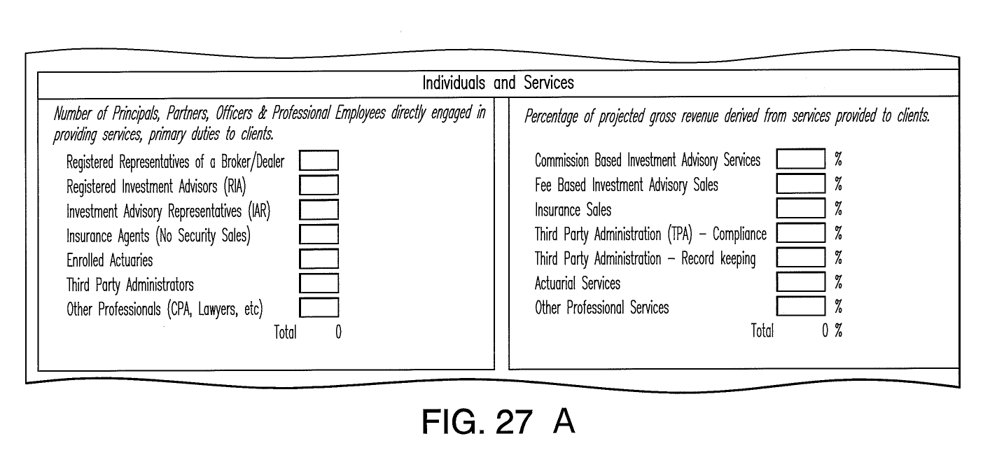

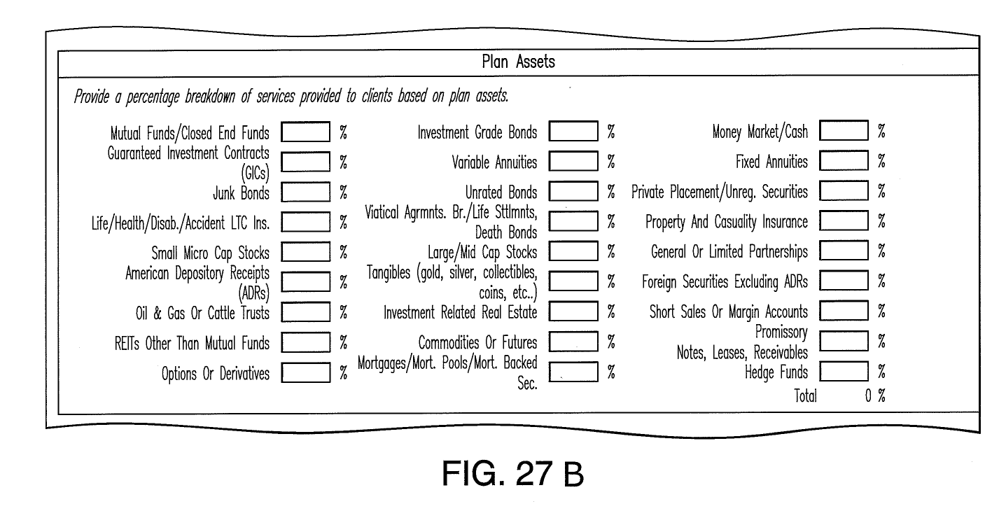

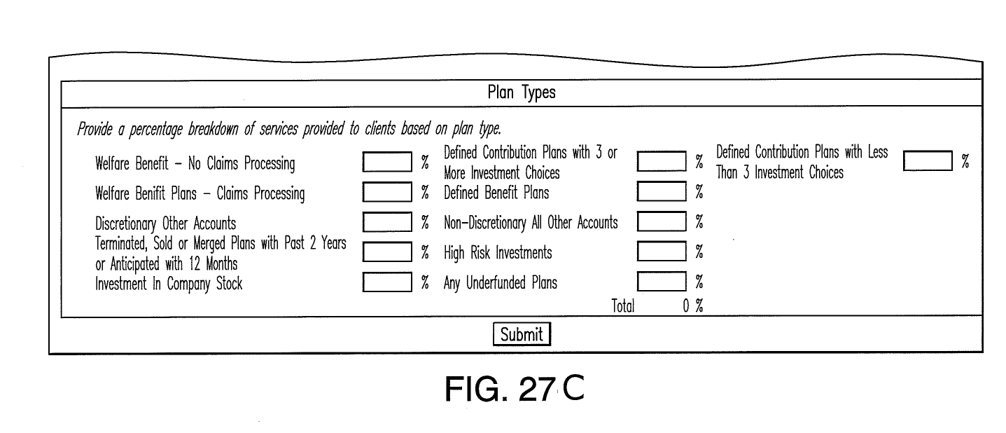

With reference now to FIGS. 25-27, shown is an illustrative example regarding Error and Omissions Insurance, as processed by system 100. For instance, getting an online quote or ordering Error and Omissions Insurance online, via system 100, is shown in FIG. 25. For instance, when a user clicks on the “Get a Quote for Insurance” or “Order Errors & Omissions Insurance” button shown in FIG. 25, system 100 generates the webpage shown in FIG. 26. And clicking on the “Get a Quote for Insurance” or Order Errors & Omissions Insurance, produces a page such as that shown in FIG. 26.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a disclosure of systems and methods for improved bond purchasing, in such full, clear, concise, and exact terms as to enable any person skilled in the art to which it pertains to make and use these systems and methods. The present disclosure is, however, susceptible to modifications and alternative method steps from those discussed above that are fully equivalent. Consequently, the present disclosure is not limited to the particular embodiments disclosed. On the contrary, the present disclosure encompasses all modifications and alternative constructions and methods coming within the spirit and scope of the present invention.

What is claimed is:

1. A computer-implemented method for processing and issuing bonds in a remote computer bond processing system, said method comprising the steps of:
a user, via an on-line connected computer device, accesses the remote computer bond processing system for providing information relating to a bond purchase request;
validating said user bond request in the remote computer bond processing system dependent upon said user inputted information relating to a bond purchase request;
issuing a requested bond to said user, in real-time, contingent upon successful validation of said user bond request; and
enabling said user to immediately obtain an issued bond, via an on-line connected computer device.

2. A computer-implemented method for processing and issuing bonds in a remote computer bond processing system as recited in claim 1 wherein the step of enabling the user to immediately obtain an issued bond includes enabling the user to print the issued bond.

3. A computer-implemented method for processing and issuing bonds in a remote computer bond processing system as recited in claim 1, wherein the user requested bond is a ERISA bond.

4. A computer-implemented method for processing and issuing bonds in a remote computer bond processing system as recited in claim 1, wherein the remote computer bond processing system is further configured and adapted to issue Error and Omissions insurance.

5. A computer-implemented method for processing and issuing bonds in a remote computer bond processing system as recited in claim 5, further including the steps of providing a questionnaire process for processing and issuing said Error and Omissions insurance.

6. A computer-implemented method for processing and issuing bonds in a remote computer bond processing system as recited in claim 1, wherein the remote computer bond processing system is further adapted and configured to provide a line of credit to a said user.

7. A computer-implemented method for processing and issuing bonds in a remote computer bond processing system as recited in claim 6, further including the steps of providing a bid bond to a user for providing said line of credit.

8. A computer-implemented method for processing and issuing bonds in a remote computer bond processing system as recited in claim 1, wherein the remote computer bond processing system is further adapted and configured to provide Fiduciary Liability Insurance to a said user.

9. An apparatus to process and issue bonds online, comprising:
a memory;
a processor disposed in communication with said memory, and configured to issue a plurality of instructions stored in the memory, wherein the instructions issue signals to:
provide a user, via an on-line connected computer device, accesses the remote computer bond processing system for providing information relating to a bond purchase request;
validate said user bond request in the remote computer bond processing system dependent upon said user inputted information relating to a bond purchase request;
issue a requested bond to said user, in real-time, contingent upon successful validation of said user bond request;
enable said user to immediately obtain an issued bond, via an on-line connected computer device and print the bond using a printing device coupled to the on-line connected computer device.

10. An apparatus to process and issue bonds online as recited in claim 9, wherein the user requested bond is a ERISA bond.

11. An apparatus to process and issue bonds online as recited in claim 9, wherein the remote computer bond processing system is further configured and adapted to issue Error and Omissions insurance.

12. apparatus to process and issue bonds online as recited in claim 11, wherein the processor further provides instructions to provide a questionnaire process for processing and issuing said Error and Omissions insurance.

13. An apparatus to process and issue bonds online as recited in claim 9, wherein the remote computer bond processing system is further adapted and configured to provide a line of credit to a said user.

14. An apparatus to process and issue bonds online as recited in claim 9, wherein the processor further provides instructions to provide a bid bond to a user for providing said line of credit.
